(19) United States
(12) Patent Application Publication
(10) Pub. No.: US 2022/0373806 A1
(43) Pub. Date: Nov. 24, 2022

(54) AUGMENTED REALITY SYSTEMS AND METHODS FOR THE VISUALLY IMPAIRED

(71) Applicant: Project Cornell LLC, Las Vegas, NV (US)

(72) Inventors: Dylan STROUD, Henderson, NV (US); Taylor SPEEGLE, Las Vegas, NV (US)

(21) Appl. No.: 17/751,382

(22) Filed: May 23, 2022

Related U.S. Application Data
(60) Provisional application No. 63/192,061, filed on May 23, 2021.

(51) Int. Cl. G02B 27/01; G06F 3/01; G02B 27/00

(52) U.S. Cl. CPC G02B 27/0172; G06F 3/013; G02B 27/0093; G02B 2027/0138; G02B 2027/0178

(57) ABSTRACT

This disclosure relates generally to mixed reality, and more particularly to augmented reality systems and methods for the visually impaired. In one embodiment, an augmented-reality electronic glass apparatus is disclosed, comprising: a smart frame, comprising: a printed circuit board, a light emitting diode, a battery, and a communication module with integrated antenna; and a digital lens, comprising: a liquid crystal device display, a lens assembly, a magnetic stackable optic, an eye tracking system, a camera module, a lidar module, wherein the digital lens is magnetically attached to the smart frame.

### TECHNICAL FIELD

This disclosure relates generally to mixed reality, and more particularly to augmented reality systems and methods for the visually impaired.

### BACKGROUND

Conventional augmented reality glasses attempt to provide an interactive experience of a real-world environment in which objects that reside in the real-world are enhanced by computer-generated perceptual information. The inventors here have recognized several technical problems with such conventional systems. Conventional augmented reality glasses fail to work for legally blind and low vision people living with conditions like Macular degeneration, diabetic retinopathy, glaucoma, Retinitis Pigmentosa, Optic Nerve atrophy, Optic Neuropathy, Ocular Albinism, Stargardt Disease and more.

### SUMMARY

Embodiments of the present disclosure present technological improvements as solutions to one or more of the above-mentioned technical problems recognized by the inventors in conventional systems. Certain embodiments provide electronic glasses designed to improve visual performance for legally blind and low vision people living with conditions like Macular degeneration, diabetic retinopathy, glaucoma, Retinitis Pigmentosa, Optic Nerve atrophy, Optic Neuropathy, Ocular Albinism, Stargardt Disease and more. They utilize in a novel arrangement components which have been specifically designed and tailored to assist vision impaired peoples in hopes to improve their quality of life. In some embodiments, electronic glasses are designed, developed, and manufactured to be a two-part modular system made up of one smart frame and two digital lenses.

In some embodiments, digital lenses may be configured to easily click into various smart frames that offer unique looks and functionality for the visually impaired and blind. A digital lens may be an insert that can be easily placed into a smart frame that houses various components that help a blind or visually impaired individual see the world around them. There can be multiple shapes and aesthetic choices for digital lenses and smart frames. In some embodiments, the digital lens may display the user's eyes on a front facing glass display. This may create a more personal interaction with those not wearing the glasses. Such a display would still allow for front facing camera sensors to capture the environment. The user's eye may be captured utilizing eye-facing cameras.

In some embodiments, smart frames may house various electrical, optical, and electronic components inside that drive and hold the digital lenses. In some embodiments, the smart frame may be a unibody design, and may be structurally made up of rims, nose-bridge, nose pads, and/or arms (temples, temple tips, hinges, endpieces). In some embodiments, wearers may easily swap different smart frames which each offer special features, functionality, aesthetic and weight for different situations and settings.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary augmented reality apparatus 100 according to some embodiments of the present disclosure.

FIGS. 2A-B illustrate exemplary aspects of augmented reality apparatus 100 according to some embodiments of the present disclosure.

FIG. 3 illustrates further exemplary aspects of augmented reality apparatus 100 according to some embodiments of the present disclosure.

FIG. 4 illustrates an exemplary augmented reality apparatus 400 according to some embodiments of the present disclosure.

FIG. 5 illustrates an exemplary augmented reality apparatus 500 according to some embodiments of the present disclosure.

FIG. 6 illustrates an exemplary augmented reality apparatus 600 according to some embodiments of the present disclosure.

FIGS. 7A-B illustrate exemplary aspects of augmented reality apparatuses according to some embodiments of the present disclosure.

FIG. 8 illustrates exemplary aspects of an augmented reality apparatus according to some embodiments of the present disclosure.

FIGS. 9-10 illustrate exemplary aspects of augmented reality charging cases according to some embodiments of the present disclosure.

FIGS. 11-57 illustrate various exemplary aspects of augmented reality apparatuses according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

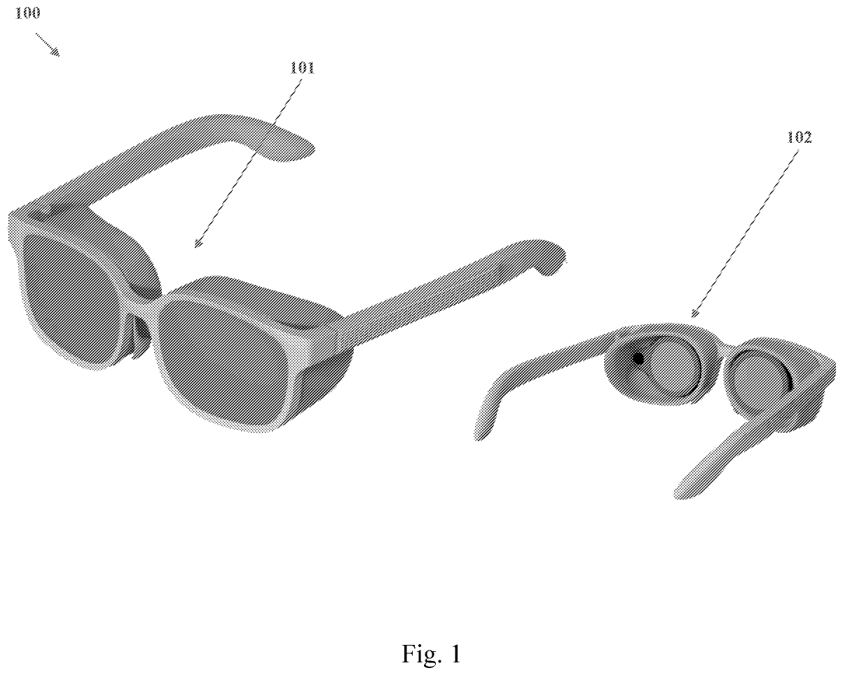

FIG. 1 illustrates an exemplary augmented reality apparatus 100 according to some embodiments of the present disclosure. In some embodiments, augmented reality apparatus 100 may be configured to improve a person's vision using augmented and/or virtual reality, while making the person feel integrated into everyday life. For example, augmented reality apparatus 100 may look similar to normal glasses, but, as shown in frontal view 101, may include optical and/or electronic equipment configured to provide an enhanced augmented/virtual reality experience for the person. Further, as shown in rear view 102, the augmented reality apparatus 100 may include lenses, cameras, tracking sensors, and/or other optical and/or electronic equipment to provide the enhanced augmented/virtual reality experience.

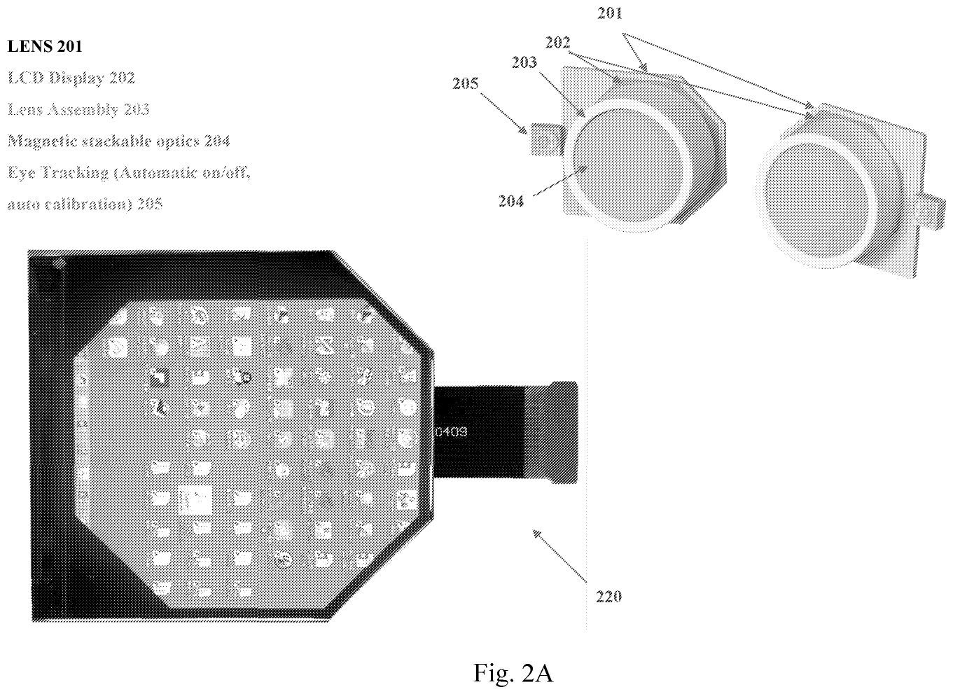

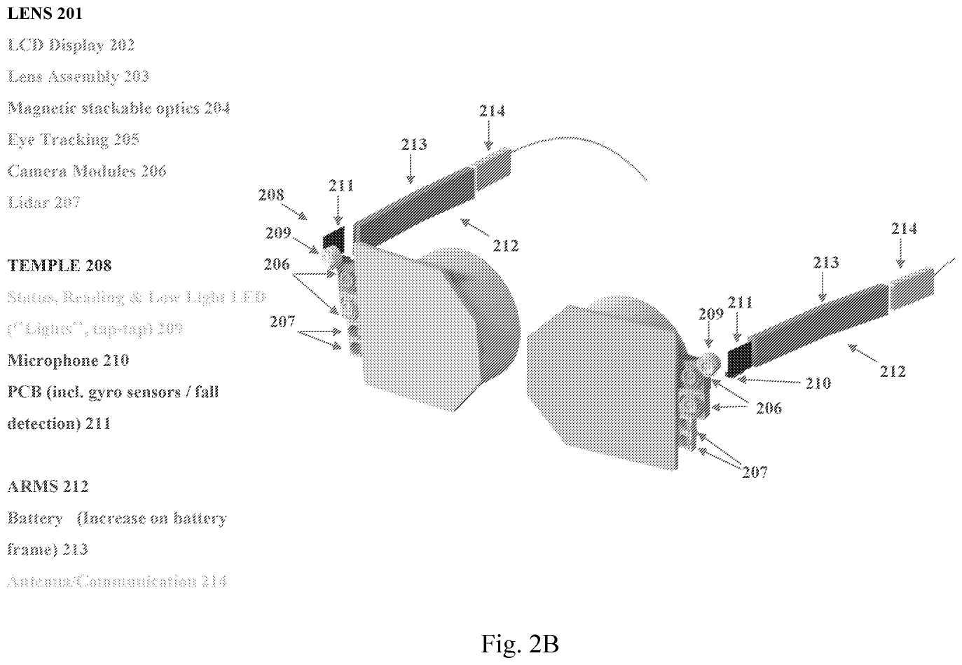

FIGS. 2A-B illustrate exemplary aspects of augmented reality apparatus 100 according to some embodiments of the present disclosure. With reference to FIG. 2A, in some embodiments, augmented reality apparatus 100 may include a lens system 201. For example, two lens systems 201 may be provided, one for each eye of the person wearing augmented reality apparatus 100. Each lens system 201 may have associated with it a display, such as LCD display 202. For example, there may be provided a LCD display 202 for each eye of the person wearing augmented reality apparatus 100. For example, the LCD display 202 may include a 45.3 mm×42.2 mm, 1,600×1,600-pixel LCD providing approximately 1058 ppi resolution. A shown in 220, LCD display 202 may provide a graphical user display and/or interface providing graphical information to the user (e.g., as an overlay over the person's real environment viewable through lens system 201, and/or as a virtual reality experience), and may serve as an interface for the person wearing augmented reality apparatus 100 to provide user input (e.g., using hand/eye gestures, audible, or other input mechanism).

In some embodiments, augmented reality apparatus 100 may include lens assembly 203. For example, lens assembly 203 may be configured to improve visual performance for legally blind and low vision people living with conditions like Macular degeneration, diabetic retinopathy, glaucoma, Retinitis Pigmentosa, Optic Nerve atrophy, Optic Neuropathy, Ocular Albinism, Stargardt Disease, etc. In some embodiments, lens assembly 203 may be tunable. For example, the focal lens, magnification, field of view, numerical aperture, astigmatism, etc. of lens assembly 203 may be tuned by modifying the optical and/or opto-electronic components in the lens assembly 203 (e.g., based on input from eye tracking sensors 205, as discussed below). In some embodiments, lens assembly 203 may include magnetic stackable optics 204. For example, lens assembly may be configured from two or more magnetic stackable optics 204 stacked and held together by magnetic force from magnets built into the magnetic stackable optics 204. In some embodiments, sub-surface magnets in the magnetic stackable optics 204 may be used to hold the magnetic stackable optics 204 in the lens assembly 203 together, and to hold the lens assembly and/or magnetic stackable optics 204 to a frame of the augmented reality apparatus 100 (e.g., as shown in FIG. 1).

In some embodiments, augmented reality apparatus 100 may include eye tracking sensors 205. For example, eye tracking sensors 205 may be located on either side of augmented reality apparatus 100 adjacent the lens 201, LCD display 202, or lens assembly 203. In some embodiments, eye tracking sensors 205 may include one or more cameras focused on the retinas of the person wearing augmented reality apparatus 100. Further, in some embodiments, eye tracking sensors 205 may be used to automatically turn (elements of) augmented reality apparatus 100 on or off based on detecting and/or tracking and eye of the person wearing augmented reality apparatus 100. Further, in some embodiments, eye tracking sensors 205 may be used to calibrate and/or tune the lens system 201, LCD display 202, lens assembly 203, and/or magnetic stackable optics 204. In some embodiments, such calibration and/or tuning may facilitate adapting the lens system 201, LCD display 202, lens assembly 203, and/or magnetic stackable optics 204 to a person who may be ailing from conditions like Macular degeneration, diabetic retinopathy, glaucoma, Retinitis Pigmentosa, Optic Nerve atrophy, Optic Neuropathy, Ocular Albinism, Stargardt Disease, etc. In some embodiments, one of the lens system 201, LCD display 202, lens assembly 203, and/or magnetic stackable optics 204 for one eye may be calibrated and/or tuned differently than the corresponding lens system 201, LCD display 202, lens assembly 203, and/or magnetic stackable optics 204 for the other eye, based on differing inputs provided by the eye tracking systems 205 for each eye of the person wearing augmented reality apparatus 100.

In some embodiments, eye tracking cameras may be positioned on the backside of the digital lens. These may serve a variety of functions. They may detect when the device is put on or off and power on/off automatically (allows for no power button to be required). They can be used to adapt the display output based on where the user is looking (allowing for focus to be kept similar to how the human eye naturally works). They can detect the openness level of a users' eyelids and facial area around the eyes (such as squinting, widening of eyes, and blinking which can then be used to enhance focus and other levels of device output. They can also detect eye dilation which can be used to provide input to the device and software, including for the conduction of eye examinations.

With reference to FIG. 2B, in some embodiments, augmented reality apparatus 100 may include integrated cameras modules 206 on either side of augmented reality apparatus 100. For example, on either side of augmented reality apparatus 100 may be provided a 20 MP standard smartphone camera module and a 8 MP wide angle smartphone camera module. Camera modules 206 may capture pictures and/or video of the environment of the person wearing augmented reality apparatus 100. The media captured by camera modules 206 may be used to generate an augmented and/or virtual reality experience for the person wearing augmented reality apparatus 100.

In some embodiments, augmented reality apparatus 100 may include integrated lidar modules 207 on either side of augmented reality apparatus 100. Lidar modules 207 may be used for 3D laser scanning of objects in the environment of the person wearing augmented reality apparatus 100. The data captured by lidar modules 207 may be used to generate an augmented and/or virtual reality experience for the person wearing augmented reality apparatus 100. In some embodiments, located beneath the front glass lens near the outside brow position is the LiDar sensor. This may be used to better assist with real world geometry as well as object and hazard detection in the periphery.

In some embodiments, augmented reality apparatus 100 may include temple modules 208 located on either side of the augmented reality apparatus 100. Template modules 208 may be used, for example, to obtain biometric data from the person wearing augmented reality apparatus 100. The data captured by temple modules 208 may be used to generate an augmented and/or virtual reality experience for the person wearing augmented reality apparatus 100.

In some embodiments, augmented reality apparatus 100 may include status, reading, and low-light light emitting diodes (LEDs) 209. In some embodiments, the LEDs 209 may be turned on or off using voice commands and/or tapping on the LEDs 209. In some embodiments, augmented reality apparatus 100 may include microphones 210 on either side of augmented reality apparatus 100 to capture voice commands from the person wearing augmented reality apparatus 100. A microphone may be positioned near the user's temple on either side of his or her face, and/or near the ear for optimal positioning and auditory receipt.

In some embodiments, augmented reality apparatus 100 may include PCB 211. In some embodiments, PCB 211 may include accelerometers, gyroscopes, proximity sensors, motions sensors, etc. Such sensors may be used to detect if the person wearing the augmented reality apparatus 100 falls down. Data from such sensors may also be used to generate an augmented and/or virtual reality experience for the person wearing augmented reality apparatus 100. Further PCB 211 may perform the computations or processing needed for the augmented reality apparatus 100 to perform any of its functions. For example, PCB 211 may be configured for driving the LCD display 202, processing inputs (e.g., eye/hand gestures, voice commands, wireless signals) provided by the user or another system, controlling eye tracking sensors 205, calibrating and/or tuning the lens system 201, LCD display 202, lens assembly 203, and/or magnetic stackable optics 204 based on inputs provided by eye tracking sensors 205, controlling and/or processing data from camera modules 206, lidar modules 207, temple modules 208, LEDs 209, microphone 210, controlling and/or processing data from the accelerometers, gyroscopes, proximity sensors, motions sensors, etc. included in PCB 211, and providing other output signals (e.g., wireless signals, battery control signals, etc.). In general, PCB 211 may perform any computing or processing required for any of the functions of the augmented reality apparatus 100.

In some embodiments, augmented reality apparatus 100 may include arms 212. Arms 212 may serve to mechanically support the augmented reality apparatus 100 on the ears and face of the person wearing augmented reality apparatus 100. In some embodiments, arms 212 may be counterweighted at its rear end to offset the weight of the components towards the front end of the augmented reality apparatus 100. In some embodiments, arms 212 may include battery 213 to provide electrical power to the components of the augmented reality apparatus 100. In some embodiments, arms 212 may also provide a communication module/antenna 214. The communication module/antenna 214 may be utilized for wireless (e.g., Wi-Fi, Bluetooth, RF, microwave, etc.) communication with components of the augmented reality apparatus 100 or other components external to augmented reality apparatus 100.

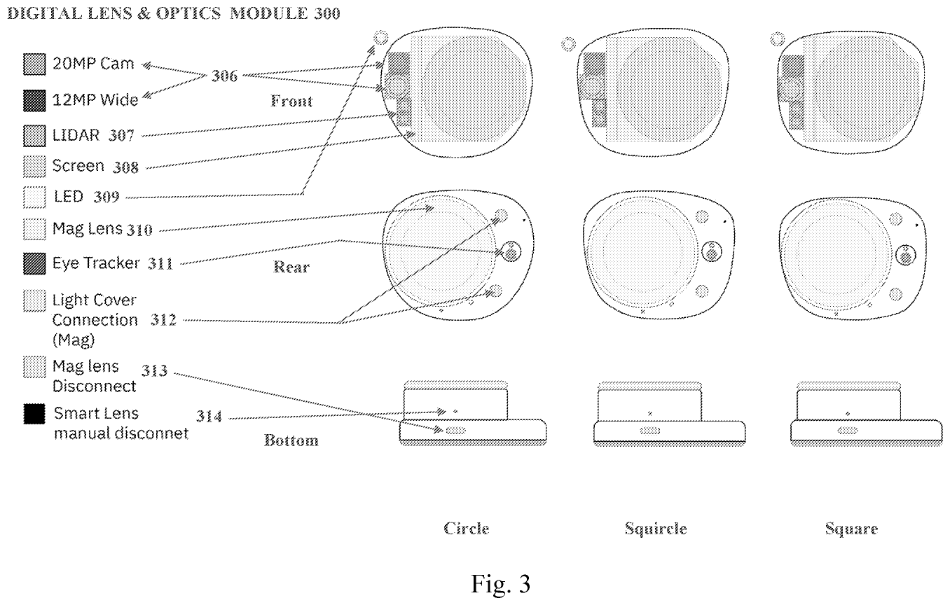

FIG. 3 illustrates further exemplary aspects of augmented reality apparatus 100 according to some embodiments of the present disclosure. For example, FIG. 3 provides front, rear, and bottom views of digital lens and optics modules 300 associated with three different frame shapes (circle, squircle, and square). As shown in FIG. 3, the digital lens and optics modules 300 may include a 20 MP standard and 12 MP wide-angle smartphone camera modules 306, lidar module 307, LCD screen 308, LEDs 309, magnetically stackable lenses 310, eye tracker 311, magnetic light cover connection pins 213, magnetic lens disconnect buttons 313, and smart lens manual disconnect button 314.

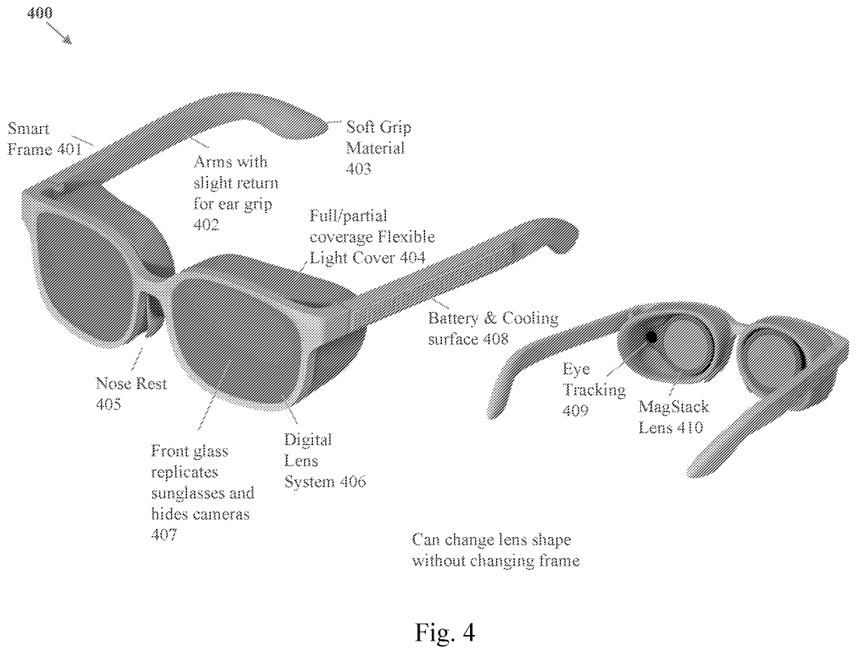

FIG. 4 illustrates an exemplary augmented reality apparatus 400 according to some embodiments of the present disclosure. In some embodiments, augmented reality apparatus 400 may include a smart frame 401, which may include mechanical, electrical, battery, and/or sensor components as discussed above with reference to FIGS. 1, 2A-B, 3. Augmented reality apparatus 400 may further include arms, which may include PCBs, batteries, communication modules, and/or antennas as discussed above. In some embodiments, arms 402 may be provided with a slight return to provide for ear grip. Arms 402 may be made of a soft grip material 403. Augmented reality apparatus 400 may further include a full/partial coverage flexible light cover 404. For example, flexible light cover 404 may fully or partially shield the eyes of the person wearing augmented reality apparatus 400 from peripheral light sources, external light sources, or any sources of light other than digital lens system 406. Augmented reality apparatus 400 may further include a nose rest 405. Augmented reality apparatus 400 may further include a digital lens system 406, which may include lenses, LCD displays, lens assemblies, magnetic stackable optics, eye tracking sensors, camera modules, lidar modules, temple modules, status, reading, and/or low-light LEDs, microphones, accelerometers, gyroscopes, proximity sensors, motion sensors, PCBs, etc., as discussed above. Augmented reality apparatus 400 may further include front glass 407, which may replicate sunglasses, and hide cameras and/or other components included in digital lens system 406. Augmented reality apparatus 400 may further include arms comprising batteries. The arms may also provide a surface and/or features 408 facilitating cooling of the PCB, battery, communication module, antenna, and/or any other components of the augmented reality apparatus 400. In general, components can be direct-mounted or placed in close contact with an interior surface of the frame for enhanced cooling as well as enhanced weight and space savings.

Augmented reality apparatus 400 may further include an eye tracking system 409 for tracking eye movements of a person wearing augmented reality apparatus 400. In some embodiments, eye tracking system 409 may be used to automatically turn (elements of) augmented reality apparatus 400 on or off based on detecting and/or tracking and eye of the person wearing augmented reality apparatus 400. Further, in some embodiments, eye tracking system 409 may be used to calibrate and/or tune the digital lens system 406, including LCD display, lens assembly, and/or magnetic stackable optics. In some embodiments, such calibration and/or tuning may facilitate adapting the digital lens system 406, LCD display, lens assembly, and/or magnetic stackable optics to a person who may be ailing from conditions like Macular degeneration, diabetic retinopathy, glaucoma, Retinitis Pigmentosa, Optic Nerve atrophy, Optic Neuropathy, Ocular Albinism, Stargardt Disease, etc. In some embodiments, one of the digital lens system 406, LCD display, lens assembly, and/or magnetic stackable optics for one eye may be calibrated and/or tuned differently than the corresponding digital lens system 406, LCD display, lens assembly, and/or magnetic stackable optics for the other eye, based on differing inputs provided by the eye tracking system 409 for each eye of the person wearing augmented reality apparatus 400.

Augmented reality apparatus 400 may further include a magnetically stackable lens 410. In some embodiments, the lens shape can be changed without changing frame and/or affecting the operation of any of the other components of augmented reality apparatus 400.

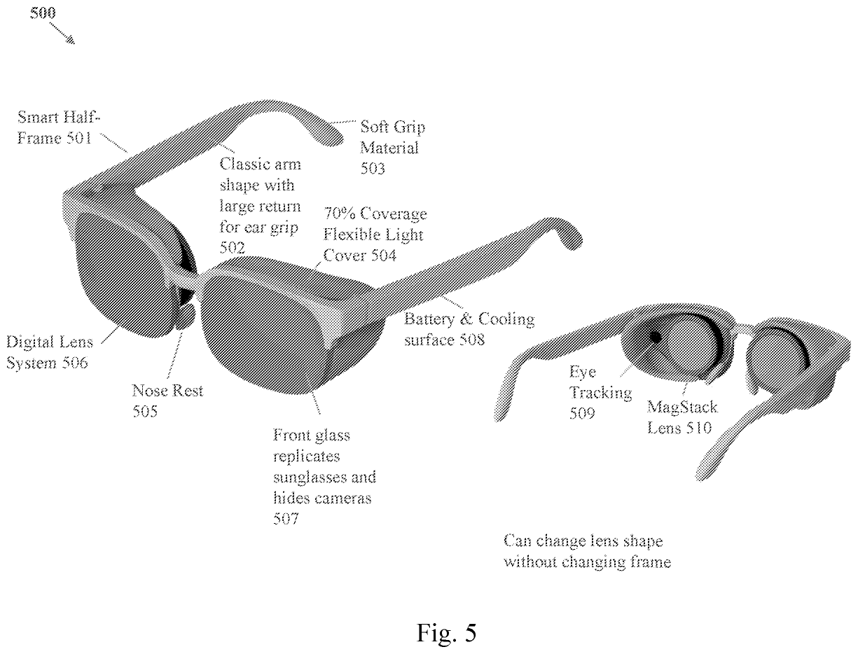

FIG. 5 illustrates an exemplary augmented reality apparatus 500 according to some embodiments of the present disclosure. In some embodiments, augmented reality apparatus 500 may include a smart half-frame 501, which may include mechanical, electrical, battery, and/or sensor components as discussed above with reference to FIGS. 1, 2A-B, 3. A half-frame trim may be considered a trim piece which could be made of a variety of potential materials and colors can be attached to the top front-facing side of the device at the point where the digital lens and frame connect. This trim piece may attach via a magnet and have a flush piece of glass to allow for LED and IR light to pass unobstructed.

Augmented reality apparatus 500 may further include arms, which may include PCBs, batteries, communication modules, and/or antennas as discussed above. In some embodiments, arms 502 may be provided with a slight return to provide for ear grip. Arms 502 may be made of a soft grip material 503. Augmented reality apparatus 500 may further include a full/partial coverage flexible light cover 504. For example, flexible light cover 504 may fully or partially shield the eyes of the person wearing augmented reality apparatus 500 from peripheral light sources, external light sources, or any sources of light other than digital lens system 506. Augmented reality apparatus 500 may further include a nose rest 505. Augmented reality apparatus 500 may further include a digital lens system 506, which may include lenses, LCD displays, lens assemblies, magnetic stackable optics, eye tracking sensors, camera modules, lidar modules, temple modules, status, reading, and/or low-light LEDs, microphones, accelerometers, gyroscopes, proximity sensors, motion sensors, PCBs, etc., as discussed above. Augmented reality apparatus 500 may further include front glass 507, which may replicate sunglasses, and hide cameras and/or other components included in digital lens system 506. Augmented reality apparatus 500 may further include arms comprising batteries. The arms may also provide a surface and/or features 508 facilitating cooling of the PCB, battery, communication module, antenna, and/or any other components of the augmented reality apparatus 500.

Augmented reality apparatus 500 may further include an eye tracking system 509 for tracking eye movements of a person wearing augmented reality apparatus 500. In some embodiments, eye tracking system 509 may be used to automatically turn (elements of) augmented reality apparatus 500 on or off based on detecting and/or tracking and eye of the person wearing augmented reality apparatus 500. Further, in some embodiments, eye tracking system 509 may be used to calibrate and/or tune the digital lens system 506, including LCD display, lens assembly, and/or magnetic stackable optics. In some embodiments, such calibration and/or tuning may facilitate adapting the digital lens system 506, LCD display, lens assembly, and/or magnetic stackable optics to a person who may be ailing from conditions like Macular degeneration, diabetic retinopathy, glaucoma, Retinitis Pigmentosa, Optic Nerve atrophy, Optic Neuropathy, Ocular Albinism, Stargardt Disease, etc. In some embodiments, one of the digital lens system 506, LCD display, lens assembly, and/or magnetic stackable optics for one eye may be calibrated and/or tuned differently than the corresponding digital lens system 506, LCD display, lens assembly, and/or magnetic stackable optics for the other eye, based on differing inputs provided by the eye tracking system 509 for each eye of the person wearing augmented reality apparatus 500.

Augmented reality apparatus 500 may further include a magnetically stackable lens 510. In some embodiments, the lens shape can be changed without changing frame and/or affecting the operation of any of the other components of augmented reality apparatus 500.

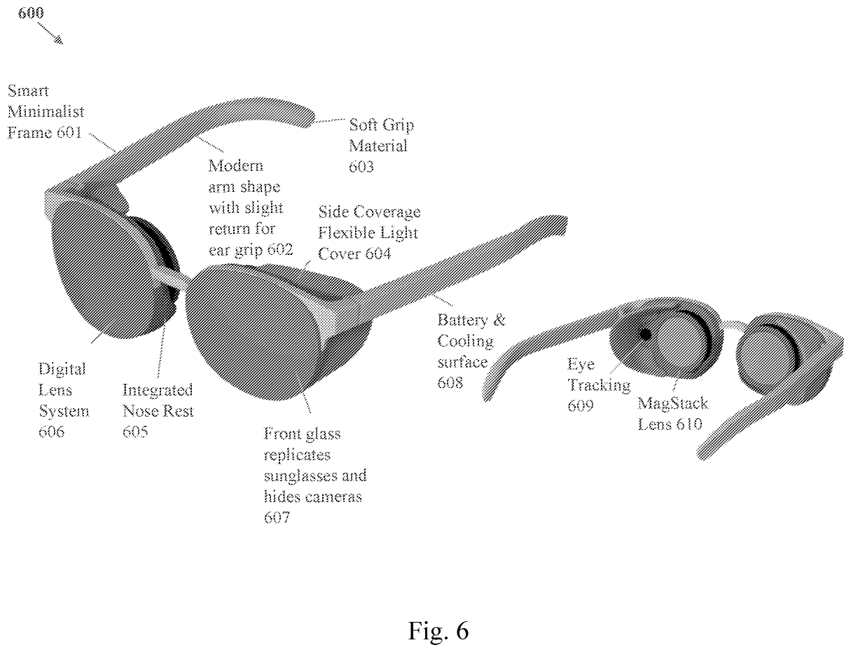

FIG. 6 illustrates an exemplary augmented reality apparatus 600 according to some embodiments of the present disclosure. In some embodiments, augmented reality apparatus 600 may include a smart minimalist frame 601, which may include mechanical, electrical, battery, and/or sensor components as discussed above with reference to FIGS. 1, 2A-B, 3. Augmented reality apparatus 600 may further include arms, which may include PCBs, batteries, communication modules, and/or antennas as discussed above. In some embodiments, arms 602 may be provided with a slight return to provide for ear grip. Arms 602 may be made of a soft grip material 603. Augmented reality apparatus 600 may further include a full/partial coverage flexible light cover 604. For example, flexible light cover 604 may fully or partially shield the eyes of the person wearing augmented reality apparatus 600 from peripheral light sources, external light sources, or any sources of light other than digital lens system 606. Augmented reality apparatus 600 may further include an integrated nose rest 605. Augmented reality apparatus 600 may further include a digital lens system 606, which may include lenses, LCD displays, lens assemblies, magnetic stackable optics, eye tracking sensors, camera modules, lidar modules, temple modules, status, reading, and/or low-light LEDs, microphones, accelerometers, gyroscopes, proximity sensors, motion sensors, PCBs, etc., as discussed above. Augmented reality apparatus 600 may further include front glass 607, which may replicate sunglasses, and hide cameras and/or other components included in digital lens system 606. Augmented reality apparatus 600 may further include arms comprising batteries. The arms may also provide a surface and/or features 608 facilitating cooling of the PCB, battery, communication module, antenna, and/or any other components of the augmented reality apparatus 600.

Augmented reality apparatus 600 may further include an eye tracking system 609 for tracking eye movements of a person wearing augmented reality apparatus 600. In some embodiments, eye tracking system 609 may be used to automatically turn (elements of) augmented reality apparatus 600 on or off based on detecting and/or tracking and eye of the person wearing augmented reality apparatus 600. Further, in some embodiments, eye tracking system 609 may be used to calibrate and/or tune the digital lens system 606, including LCD display, lens assembly, and/or magnetic stackable optics. In some embodiments, such calibration and/or tuning may facilitate adapting the digital lens system 606, LCD display, lens assembly, and/or magnetic stackable optics to a person who may be ailing from conditions like Macular degeneration, diabetic retinopathy, glaucoma, Retinitis Pigmentosa, Optic Nerve atrophy, Optic Neuropathy, Ocular Albinism, Stargardt Disease, etc. In some embodiments, one of the digital lens system 606, LCD display, lens assembly, and/or magnetic stackable optics for one eye may be calibrated and/or tuned differently than the corresponding digital lens system 606, LCD display, lens assembly, and/or magnetic stackable optics for the other eye, based on differing inputs provided by the eye tracking system 609 for each eye of the person wearing augmented reality apparatus 600.

Augmented reality apparatus 600 may further include a magnetically stackable lens 610. In some embodiments, the lens shape can be changed without changing frame and/or affecting the operation of any of the other components of augmented reality apparatus 600.

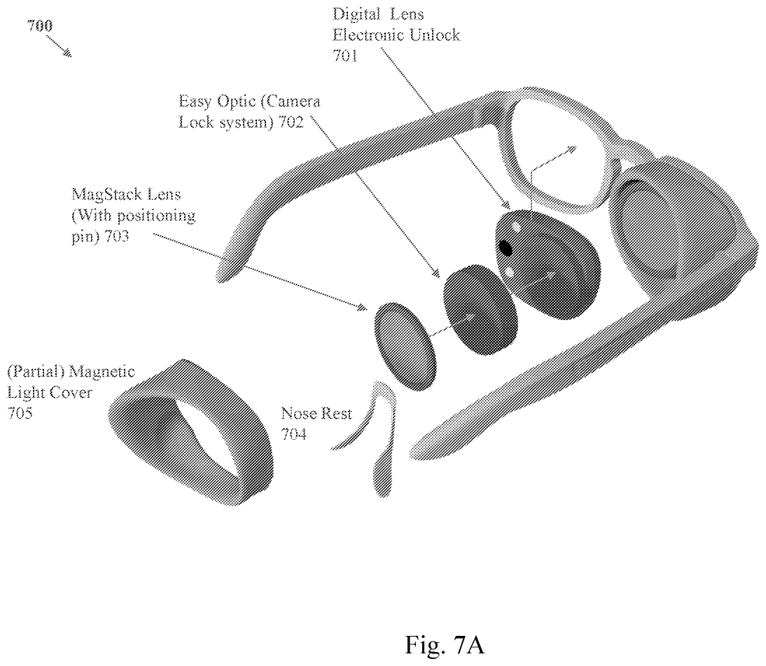

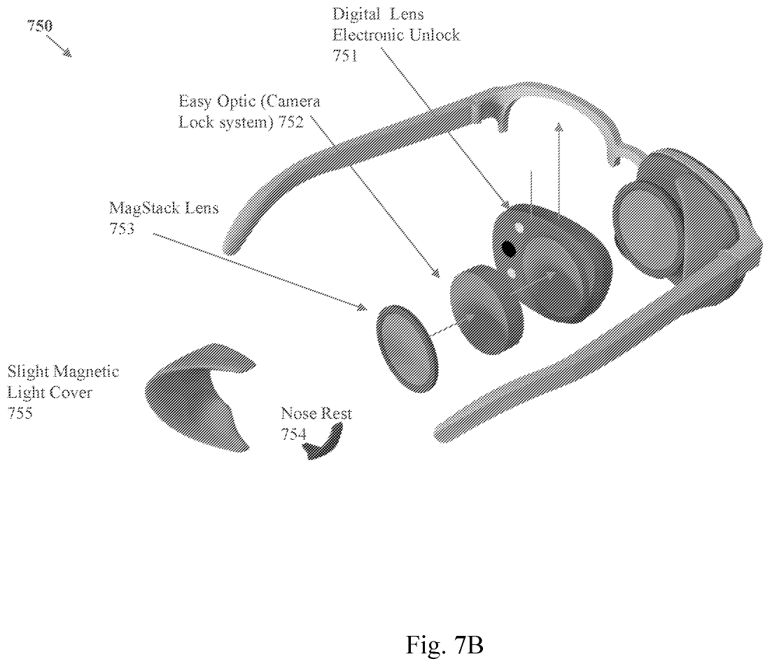

FIGS. 7A-B illustrate exemplary aspects of augmented reality apparatuses 700 and 750 according to some embodiments of the present disclosure. With reference to FIG. 7A, in some embodiments, an augmented reality apparatus 700 may include a full frame, and a digital lens system including a LCD display, lens assembly, magnetic stackable lens. The LCD display may include a digital lens electronic unlock system 701, by which the digital lens may be electronically locked to and unlocked from the frame of augmented reality apparatus 700. The lens assembly may include an easy optic (camera lock system) 702, by which the lens assembly may be electronically locked to and unlocked from the LCD display and/or the magnetic stackable lens. The magnetic stackable lens may include a positioning pin 703 to help position and align the magnetic stackable lens to the lens assembly. The augmented reality apparatus 700 may further include a nose rest 704 and a partial/full magnetic light cover 705.

With reference to FIG. 7B, in some embodiments, an augmented reality apparatus 750 may include a partial frame, and a digital lens system including a LCD display, lens assembly, magnetic stackable lens. The LCD display may include a digital lens electronic unlock system 751, by which the digital lens may be electronically locked to and unlocked from the frame of augmented reality apparatus 750. The lens assembly may include an easy optic (camera lock system) 752, by which the lens assembly may be electronically locked to and unlocked from the LCD display and/or the magnetic stackable lens. The magnetic stackable lens may include a positioning pin 753 to help position and align the magnetic stackable lens to the lens assembly. The augmented reality apparatus 750 may further include a nose rest 754 and a partial/full magnetic light cover 755.

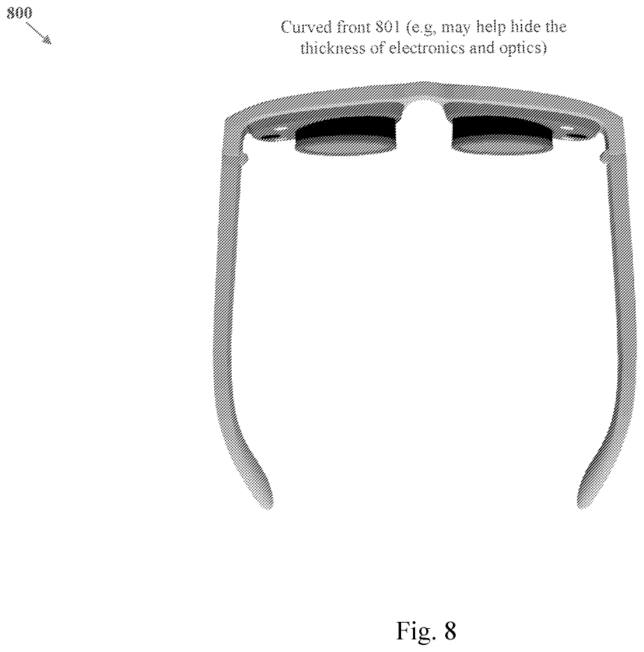

FIG. 8 illustrates exemplary aspects of an augmented reality apparatus 800 according to some embodiments of the present disclosure. In some embodiments, an augmented reality apparatus 800 may include a curved front 801, which may for example help hide the thickness of electronics and optics from an observer looking at the person wearing the augmented reality apparatus 800.

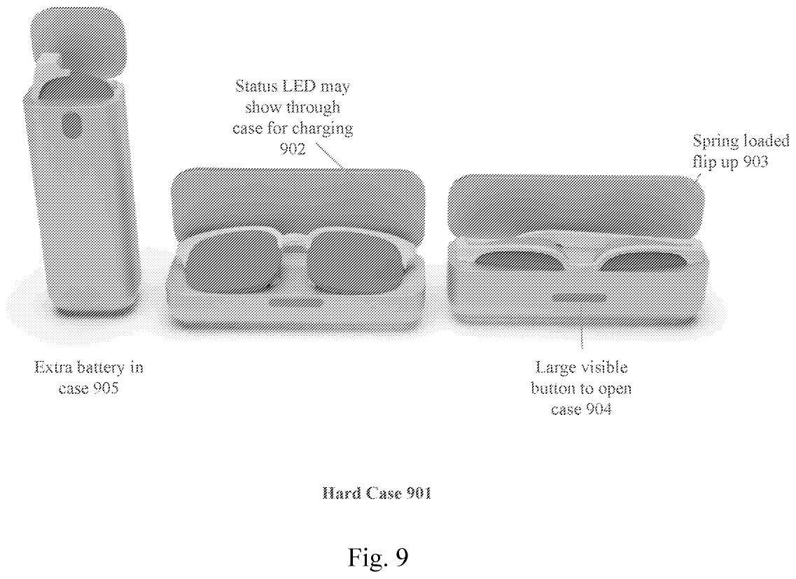

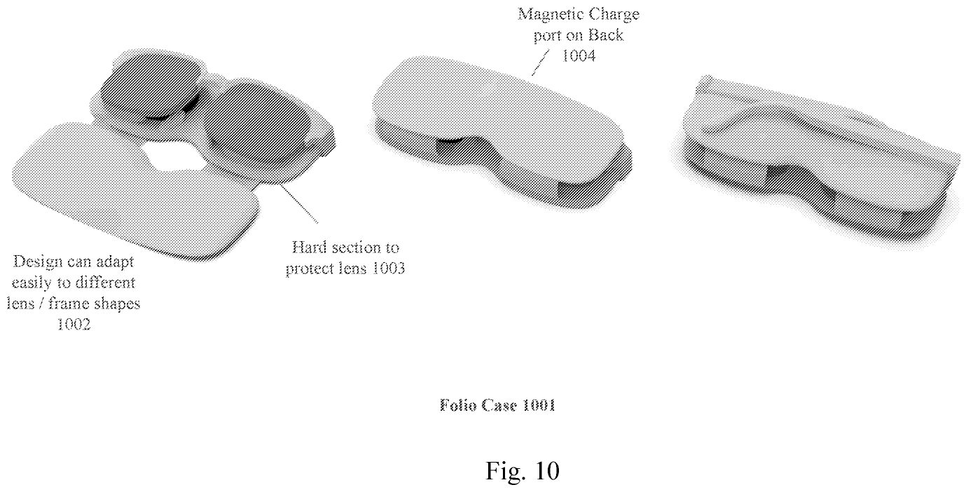

FIGS. 9-10 illustrate exemplary aspects of augmented reality charging cases according to some embodiments of the present disclosure. With reference to FIG. 9, in some embodiments, a hard case 901 may include a status LED 902, which may show through the case 901 to indicate the status of charging. Hard case 901 may also include a spring-loaded flip up mechanism 903. Hard case 901 may further include a large visible button 904 to open the hard case 901. Hardcase 901 may also be provided with a compartment 905 to store and extra battery in the case.

With reference to FIG. 10, in some embodiments, a folio case 1001 may include relief features 1002 designed to adapt easily to and accommodate different lens/frame shapes. Folio case 1001 may further include a hard section to protect lens 1003 from external stimuli. Folio case 1001 may also include a magnetic charge port 1004, for example on a back surface.

FIGS. 11-57 illustrate various exemplary aspects of augmented reality apparatuses according to some embodiments of the present disclosure. With reference to FIG. 11, in some embodiments, an augmented reality apparatus may include the frame base 1100. The augmented reality apparatus may also include a metal frame 1102 and arms 1103 on either side of the frame base 1100, coupled via an electromechanical hinge 1101. In some embodiments, the apparatus may also include one or more pogo pin connectors 1104 that may be configured to provide mechanical and/or electrical connection. In some instances, the pogo pin connectors 1104 may also be used for alignment. In general, a digital lens may connect digitally to a smart frame, as well as mechanically. Pogo pins may be used to create such digital/electrical connection. The use of the pogo pin may provide a highly-reliable, precision made interconnected solution to facilitate modular nature of the apparatus. The augmented reality apparatus may also include hook in points 1105 that can be used for alignment and/or mechanical/electrical connectivity. An outward protruding area of the frame may be met by an equal inward protruding notch on the digital lens which may create a hook effect helping to secure the digital lens and frame together (which may be working in conjunction with the Pogo Pin, Sprint load lock, and grooved joint).

The arms 1103 can have soft touch inserts 1106 as shown, which can be made of silicone.

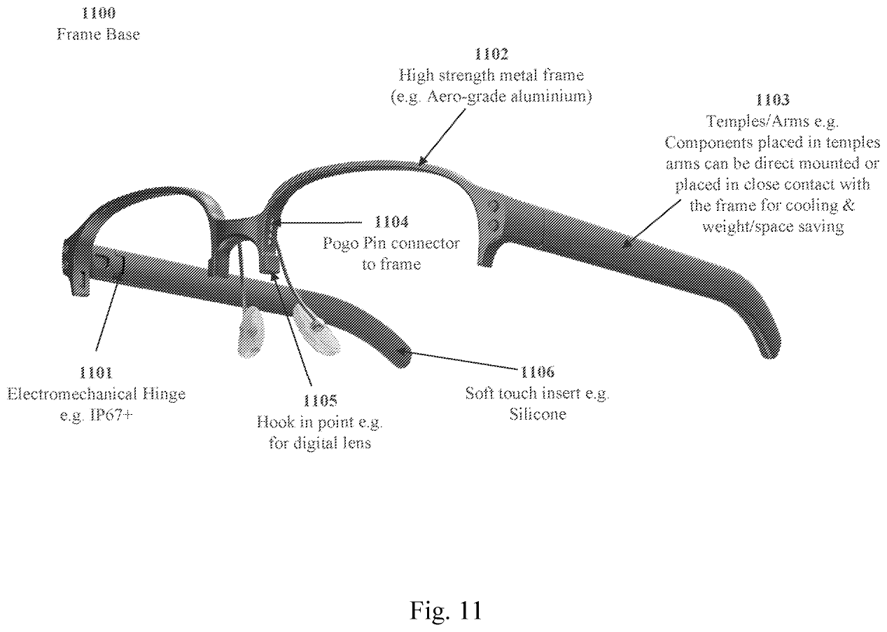

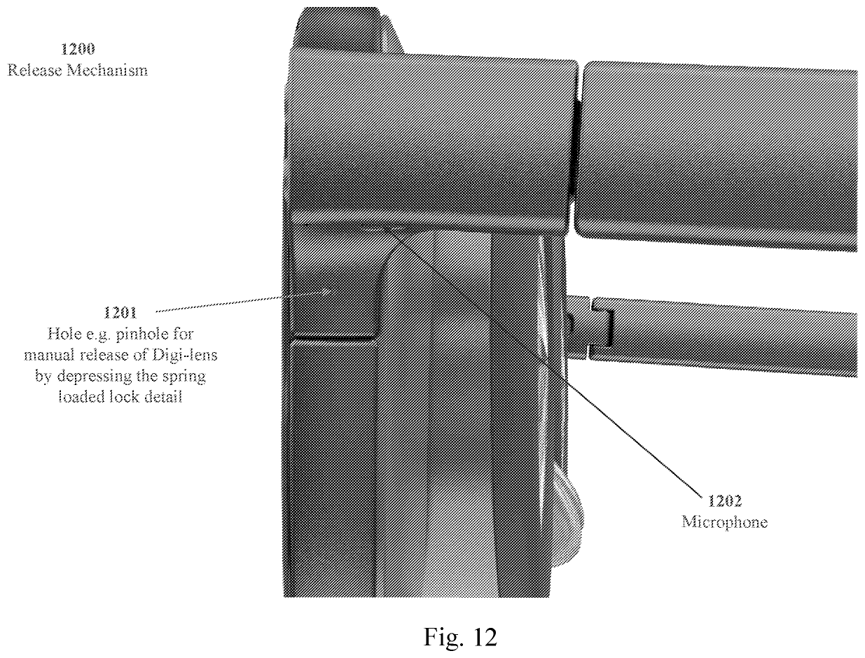

With reference to FIG. 12, in some embodiments, an augmented reality apparatus may include a release mechanism 1200 to manually release a digital lens from the frame. The apparatus includes a hole or pinhole 1201 that can be configured to provide the manual release mechanism by activating release upon depressing a spring-loaded lock. A pinhole mechanical release may be integrated into the frame which, when engaged, depresses a spring-loaded locking detail and allows for the removal of the digital lens from the smart frame. Located on the digital lens, the spring loaded locking detail may be used to aid in securing the digital lens to the smart frame. When securing the digital lens to the smart frame, the locking detail may be depressed and, when the lens is rotated into place, may be pushed by the springs to lock securely into the receiving indentation on the frames. To release, the locking detail may be depressed through the pinhole on the frames while the lens is being rotated out. The use of color on this detail aids in visibility. In some embodiments, the release may be done by rotating the lens out while the release is depressed. In some embodiments, the apparatus can include a microphone 1202.

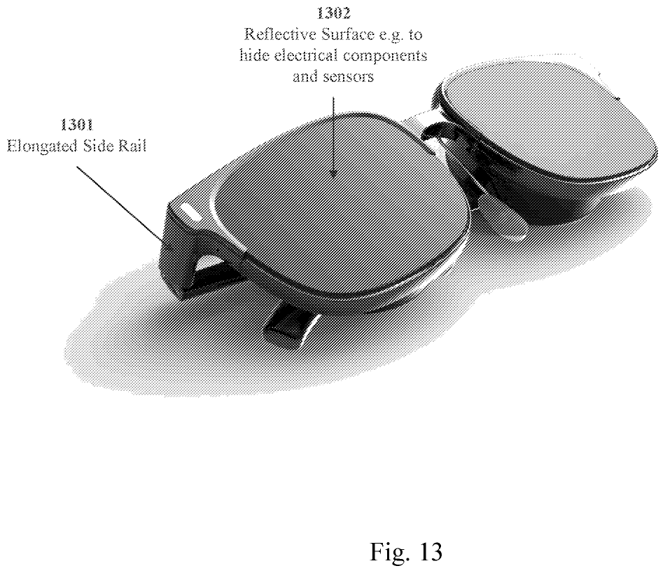

With reference to FIG. 13, in some embodiments, an augmented reality apparatus may include an elongated side rail 1301 that can be configured to include electrical/electronic components, and/or communication devices as necessary. An elongated side rail may be incorporated into the frame to allow for core componentry to be accessible in the core frame before being connected to componentry in the extended temples, which may primarily house batteries. In some embodiments, such an arrangement may make it possible to close the arms with a light shield installed.

The apparatus can include an outer surface of the digital lens and/or LCD display that is a reflective surface 1302 configured to hide electrical components, sensors, and/or the like. In some embodiments, a reflective one-way glass surface may enable the reasonable hiding of the electrical components and sensors (such as camera systems, ambient light, and LIDAR) which sit underneath from external viewers. In some embodiments, the one-way reflective surface does not inhibit the camera or sensor systems. An ambient light sensor may be used to detect the external environment's lighting conditions. These can then be used by the software to determine adjustments to the devices output and performance. For example, a very low light environment can be detected, which could automatically enable the LED or Infrared Lights.

With reference to FIG. 14, in some embodiments, an augmented reality apparatus may have a frameless digital lens or frame design 1402. The apparatus may include one or more LEDs located at a lateral position with respect to the digital lens and emitting light in the infrared and/or visible range. Each side of a smart frame may have a set of both types of lights (e.g., left side has both LED and Infrared, right side has both LED and Infrared). The lights may pass through their own independent lenses which may manipulate the output of the light (e.g., such as creating a coned output). These lights can be enabled through input of the user, as well as through software detection of the lighting environment determining the need to have them automatically activated or not. A seamless glass cover may be placed over the 2 light types on each side creating a merged cosmetic appearance.

In some embodiments, the LEDs may be coupled with lenses designed to focus the emitted light as desired.

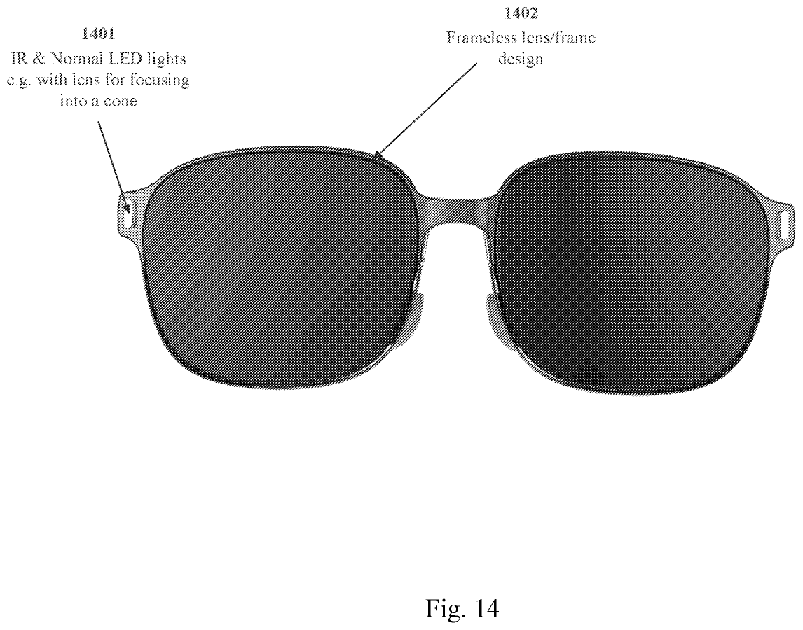

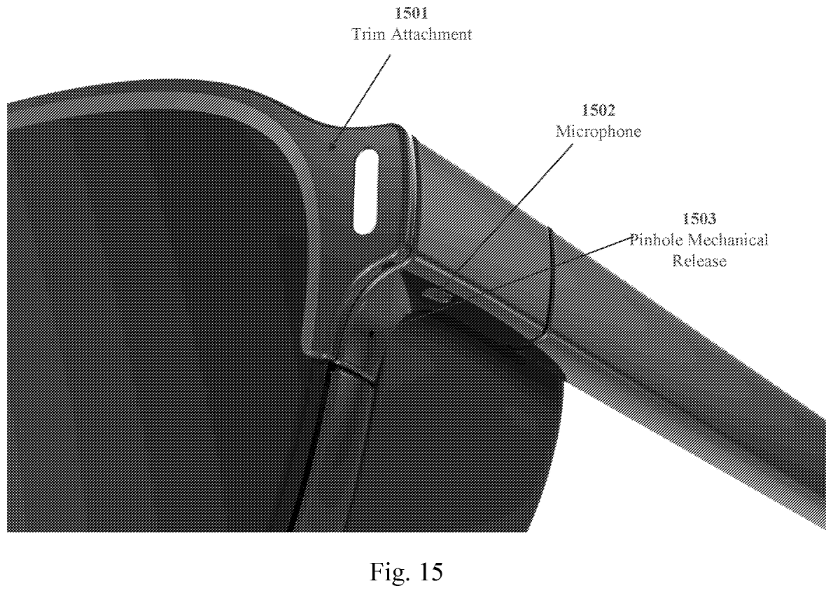

FIG. 15, illustrates an augmented reality apparatus according to an embodiment. In the embodiment shown, the apparatus may include a trim attachment 1501. Aesthetic frame trim may be attachable via magnets on the front side of the frame/lens. This may allow for greater customization of visual aesthetic to the user's preferences while not requiring modifications to the core frame and lens system. The apparatus can also include a microphone 1502 situated on an lower side of one or both arms. The apparatus can include a pinhole mechanism 1503 to manually release the digital lens and/or LCD display. Some embodiments may not require the use of trim attachments. In this case, a term such as a frameless or minimal bezel could be used to describe this state. In such embodiments, the trim may be attached by magnets.

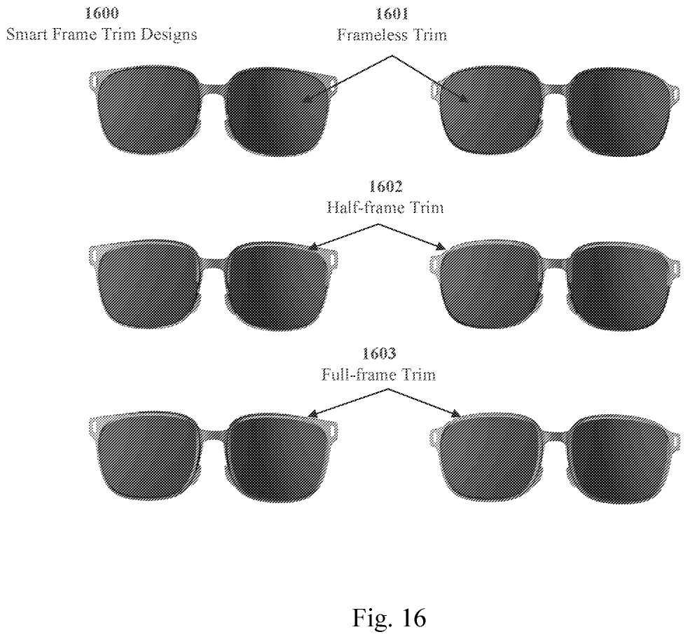

As shown in FIG. 16, in some embodiments, an augmented reality apparatus may be configured to suit a variety of frame trim designs. The illustrations in FIG. 16 show a frameless trim 1601, a half-frame trim 1602, and a full-frame trim 1603. A full-frame trim may be a trim piece which could be made of a variety of potential materials and colors can be attached to the bottom front-facing side of the apparatus on the digital lens. This trim piece may attach via a magnet. When this piece and the half-frame are both attached simultaneously, it may create a fully complete shape around the border of the digital lens. The full-frame trim piece may attach via a magnet and have a flush piece of glass to allow for LED and IR light to pass unobstructed.

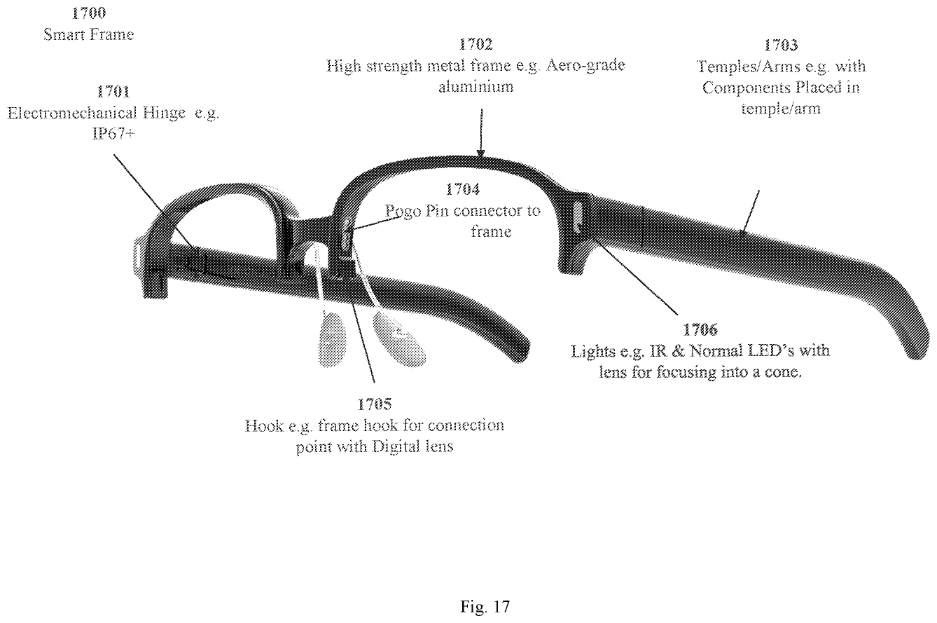

With reference to FIG. 17, in some embodiments, an augmented reality apparatus may include a smart frame 1700. The apparatus can include a high strength metal frame 1702 and arms 1703 on either side of the frame 1702. The arms 1703 can include components placed within as described previously. The arms 1703 can be coupled to the frame 1702 on either side via electromechanical hinges 1701 configured to provide mechanical coupling and stability. In some embodiments, the electromechanical hinge 1701 can be configured to be water-proof. In some embodiments, the apparatus may also include one or more pogo pin connectors 1704 connector to the frame 1702 at or near a nasal bridge portion of the frame 1702. The pogo pin connectors 1704 can be configured to provide mechanical and/or electrical connection and in some instances, be used for alignment of digital lens systems onto the frame 1702. The augmented reality apparatus may also include hook in points 1705 that can be used as connection points with digital lenses. The hook in points 1705 can also be used for alignment and/or mechanical/electrical connectivity. The frame 1702 can include infrared or visible light emitting LEDs located at or near a temple portion of the frame 1702. In some embodiments, the LEDSs may include lenses for focusing the emitted light as desired.

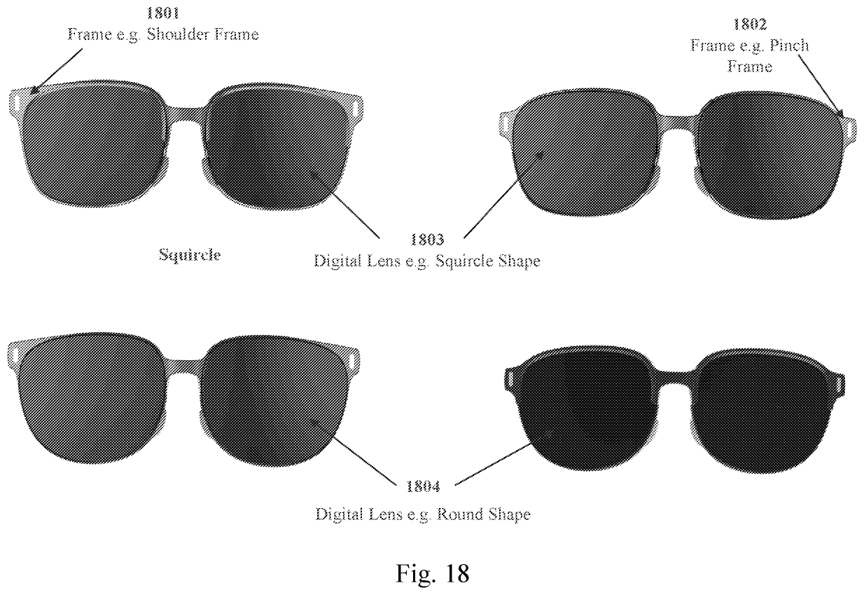

With reference to FIG. 18, an augmented reality apparatus can be generated in a variety of shapes for the frame, digital lens, and/or display. In some embodiments, a single frame can be used with multiple digital lens shapes. As indicated, a frame 1801 can have a shoulder frame configuration and use a digital lens 1803 with a squircle shape in some embodiments. The frame 1801 having a shoulder frame configuration can also be used with a digital lens 1804 with a round shape in some other embodiments. A shoulder frame configuration may feature a vertically higher relative connection/join position of the temple/arms and the front of the frame. Variations in frame design may impact exact component placement such as the magnetic attachment points of the trim. Similarly, a frame 1802 can have a pinch frame configuration and can be used with the digital lens 1803 with the squircle shape. In some other embodiments, the frame 1802 with pinch frame configuration can be used with a digital lens 1804 having a round shape. In a pinch frame configuration, the connection/join point of the temple/arm may be positioned lower relative to the digital lens position.

In general, digital lenses may vary in shape to accommodate component and feature variation, as well as to provide a wider range of aesthetic styles. The top connection/join shape and componentry which secures the digital lens and the frame together can remain the same while adjusting the shape of the lower portion of the digital lens.

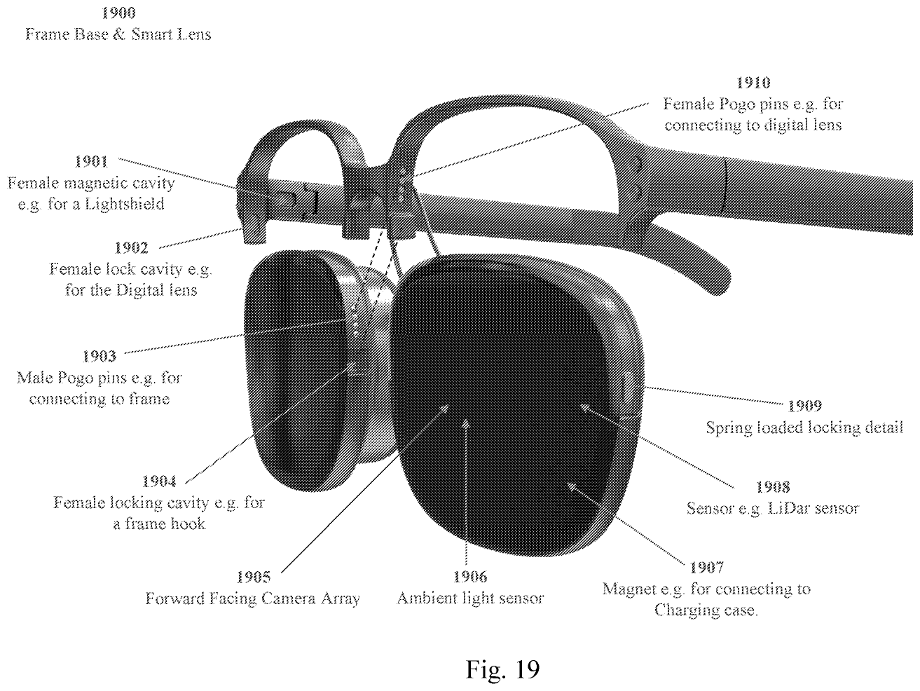

With reference to FIG. 19, in some embodiments, an augmented reality apparatus may include a frame base 1900 that includes a female magnetic cavity 1901 located at an inner side of the elongated side rail of the frame base 1900. The female magnetic cavity 1901 can be configured to couple with and/or engage with a lightshield as described herein. The frame can include a female lock cavity 1902 located at either side of the frame at a temple portion. The female lock cavity 1902 can be configured to engage with a spring-loaded locking detail 1909 situated on a digital lens to lock in the digital lens for use with the frame. The frame base 1900 can include female pogo pins 1910 located on either side of the frame and at an inner side of a nasal bridge portion of the frame. The pogo pins 1910 can be configured to connect and/or engage with counter male pogo pins 1903 that may be included on an outer circumferential surface of a digital lens as shown in FIG. 19 using a dashed line. The digital lens used with the frame base 1900 can further include female locking cavity 1904 included on the outer circumferential surface to couple and/or engage with a hook in point on a nasal bridge portion of the frame as indicated by a dashed line. The female locking cavity may be designed into the digital lens and align with a male hook in point to create a physical connection between the smart frame and the digital lens. In some embodiments, this may be the first point of connection when securing the digital lens into place. The user may position the digital lens where these two aforementioned female/male hook elements begin to align. The digital lens may then be rotated clockwise or counterclockwise depending on the side and perspective of the user so that the spring-loaded locking detail locks into its respective position and the pogo pins on the lens and frame join.

Each of the digital lenses configured to be used with the frame base 1900 can include a forward-facing camera array 1905 to capture a visual field in front or periphery of a user, an ambient light sensor 1906, and a sensor 1908 (e.g., a LIDAR sensor) configured for light-based measurements (e.g., ranging, etc.). In some embodiments, located beneath a glass lens is the forward-facing camera array. This array may be positioned to be aligned with the wearing user's natural pupil position. This array may capture the image of the environment and pass it through to the digital display. This array can include color cameras, greyscale cameras for better geometry and edge recognition, and wide-angle cameras. The digital lens can also include one or more magnets 1907 used for connecting to a charging case to charge the apparatus when not in use.

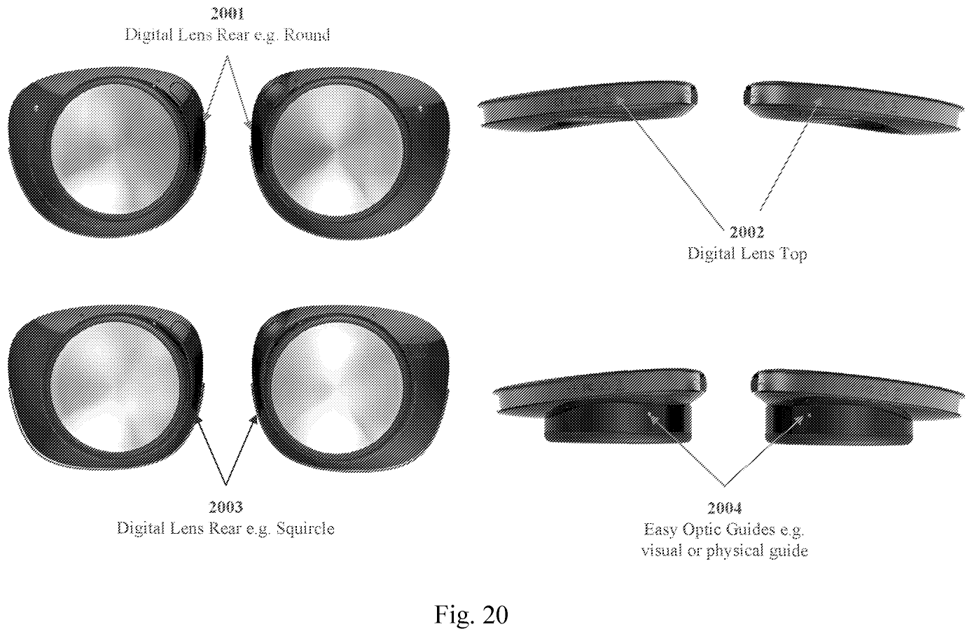

FIG. 20 illustrates a variety of digital lenses that can be used with an augmented reality apparatus according to some embodiments. A rear view of a digital lens 2001 that can be used with an augmented reality apparatus disclosed herein indicates a round shape. A top view of digital lens 2002 indicates a top edge of the digital lenses. A rear view of digital lens 2003 indicates a squircle shape, and a top view of digital lens 2004 indicates an easy optic guide for placement of the digital lens. The optic guides can be physical guides and/or visual guides that can be used for alignment and/or positioning purposes. Located on the easy optic, the easy optic guides are visual and physical guides that may aid users in positioning and securing the easy optic to the digital lens. These guides may align with marking on the digital lens. A user can align the guide with the corresponding guide on the lens, then rotate the easy optic which may align the easy optic guide with the corresponding guide on the digital lens.

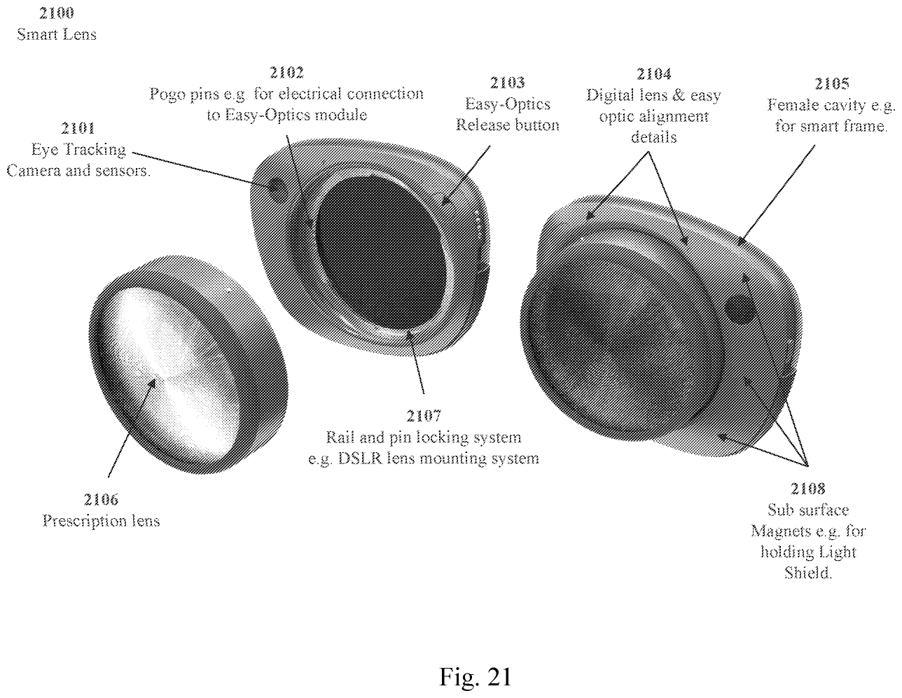

With reference to FIG. 21, in some embodiments, an augmented reality apparatus may include one or more smart lenses 2100. The pair of smart lenses 2100 can include digital lenses configured to be coupled with a frame base as described herein. The smart lens 2100 can include a receptacle for a prescription lens 2106 for a particular user. The smart lens 2100 includes pogo pins 2102 located at an outer lateral position along a periphery of the receptacle for the prescription lens 2107 to provide electrical and/or mechanical connection to an easy—optics module of the smart lens 2100. The smart lens 2100 also includes a rail and pin locking system 2107 located along the periphery of the receptacle for the prescription lens 2107 and configured to mating couple with or engage with an optical system (e.g., a DSLR lens mounting system). The rail and pin locking system 2107 may be a DSLR lens mounting system that ensures the easy optic fits perfectly into place every time, quickly and easily.

The smart lens 2100 includes eye tracking cameras and/or sensors located at a top and outer lateral position with reference to a location of the prescription lens 2106 for each eye of a user. The eye tracking camera and sensors 2101 can be configured to located and/or track a point of focus or gaze position of the user of the smart lens 2100 as a function of time. The smart lens 2100 further includes an easy-optics release button 2103 located at a top, inner lateral position with respect to a user's eye. The easy-optics release button 2103 can be configured to enable a manual release of the prescription lens 2106 or any other optical system that may be coupled to the smart lens 2100. The smart lens 2100 can also include digital or electronic modes of release of the prescription lens 2106 or any other optical system that may be coupled to the smart lens 2100. The smart lens further includes digital lens and easy optic alignments details 2104 that can be used for alignment during mounting and/or positioning of the digital lens and/or easy optics of the smart lens 2100. The smart lens 2105 also includes female cavity 2105 on a top circumferential edge of the digital lens configured to couple with or engage with a smart frame. The smart lens 2100 further includes sub surface magnets 2108 indicated by arrows in FIG. 21, for coupling with an holding a light-shield that has counter attachments that can engage with the magnets.

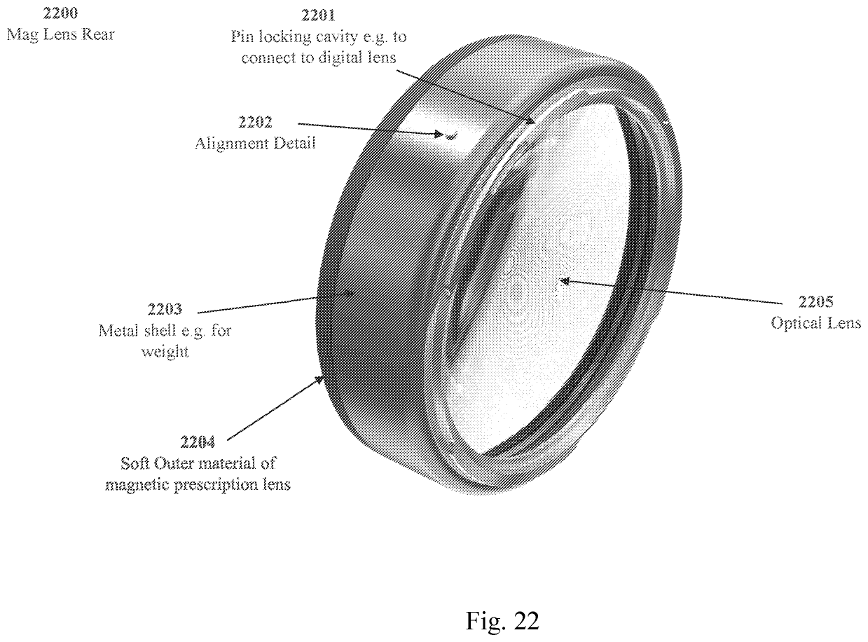

FIG. 22 is an illustration of a rear view of a mag lens 2200 that can be a magnetic lens used with a digital lens or a smart lens in an augmented reality apparatus according to some embodiments. The mag lens 2200 includes an optical lens 2205 that is centrally located. In some implementations the optical lens 2205 may include a prescription lens for a user. The mag lens 2200 includes a metal shell 2203 for the optical lens 2205 also having a soft outer material 2204. The metal shell 2203 of the mag lens 2200 can include a pin locking cavity 2201 along a circumferential periphery of one edge of the mag lens 2200. The pin locking cavity 2201 can be configured to connect and/or engage with a counter mechanism on a digital lens or a smart lens with connect the mag lens 2200 to the digital lens or smart lens. The mag lens 2200 can include alignment details 2202 that can be located at any suitable location, for example along a circumferential surface of the metal shell 2204 of the mage lens 2200. The alignments detail 2202 can be used to align the mag lens 2200 with a digital lens or smart lens for connection. The alignments detail 2202 may act as visual guides that assist the user in properly mounting the easy optic to the digital lens.

In general, an optical lens as referred to in this disclosure may be not only a traditional lens, but also a Fresnel Pancake lens, other types of folded array optics and lenses that bend the light to have unique visual and physical properties.
a. Folded/Array Optics
   i. Refractive
   ii. Fresnel
   iii. Pancake
   iv. Multi-channel
      1. Freeform multi-channel
   v. Crystal
   vi. Clover
b. Easy Optic Trade off examples
   i. Visual properties
   ii. Light efficiency, resolution, depth, fov, color accuracy, luminance, uniformity, visual defects, clarity of central or peripheral vision.
   iii. Physical properties
      1. Weight, size, shape, aesthetic

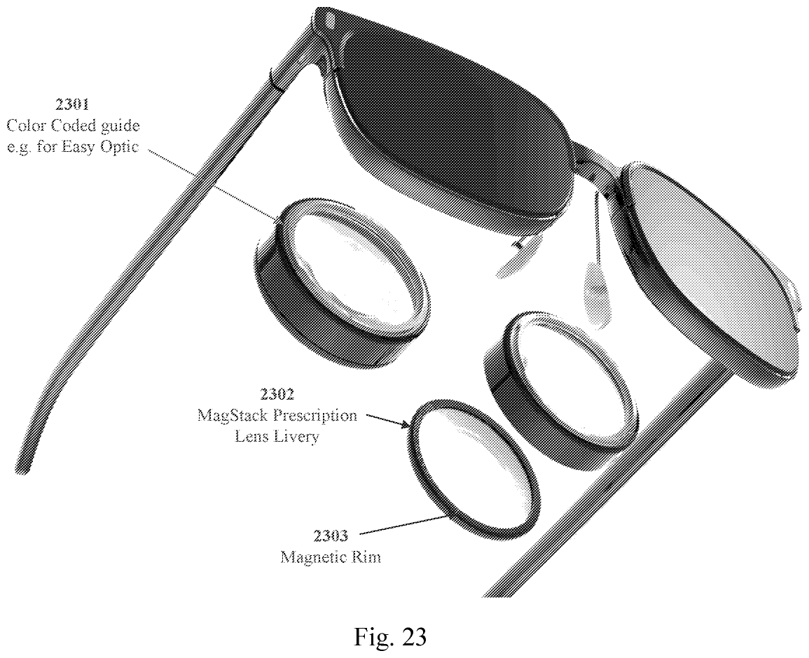

With reference to FIG. 23, in some embodiments, an augmented reality apparatus may include a magnetic stack of lenses 2302 that can include a stack of prescription lenses. The mag stack 2302 can include individual lenses each with a magnetic rim 2303 along their periphery. The magnetic rim 2203 of each lens can be configured to be used to stack the lenses together to form a mag lens for a particular prescription that can be used as an easy optic. An easy optic including such a mag lens can include a color coded guide 2301 indicating parameters associated with the easy optic and/or the mag lens (e.g., identities of magnetic lenses included in a stack of lenses within the easy optic).

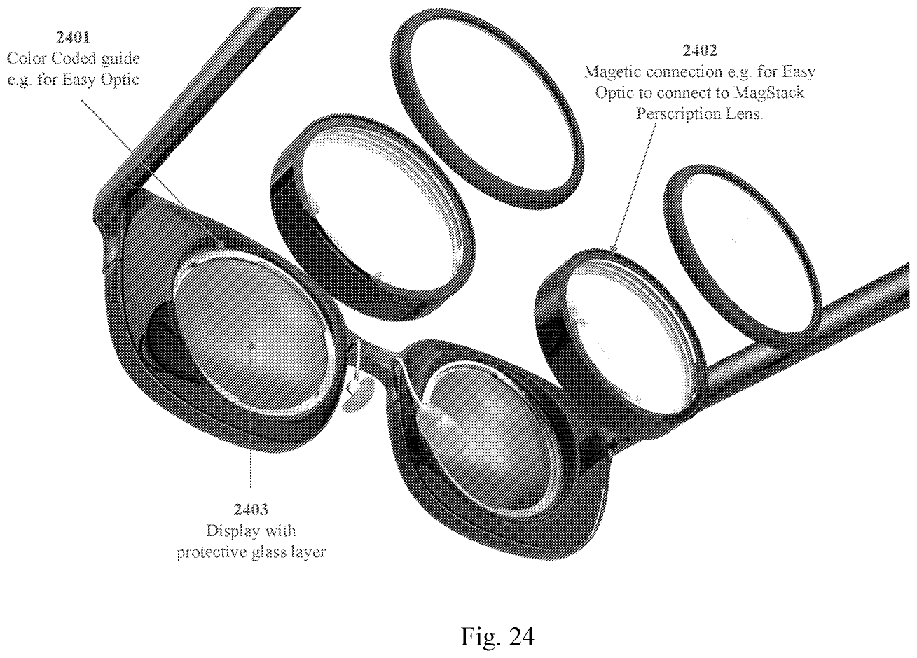

With reference to FIG. 24, in some embodiments, an augmented reality apparatus may include s digital lens configured to accept and couple to a magnetic lens using a magnetic connection 2402. The magnetic connection 2402 can be configured for easy coupling of an easy optic with a magstack of prescription lenses. As shown, the digital lens can include a display 2403 that has a protective glass layer and a color coded guide for matching and coupling with an easy optic.

FIG. 25 provides a magnified view of a frame and digital lens of an augmented reality apparatus according to some embodiments. The augmented reality apparatus can include a smart frame and a digital lens that couple to meet at a smart frame and a digital lens seam 2502. The smart frame can include a replaceable nose piece 2501. Nose piece 2501 can have multiple shapes and sizes that fit into the bridge of the smart frame. This may allow users to swap nose pieces to fit a variety of face shapes. The nose piece may be made of a singular wire bendable wire, overmolded silicone nose pads, and/or an overmolded plastic piece (this piece may be inserted into the female cavity described below and secured via a friction fit locking detail). In some embodiments, the smart frame can include a female cavity 2503 for the replaceable nose piece 2501 such that the nose piece 2501 can be removably engaged with the frame using any suitable mechanism (e.g., magnetic coupling, mechanical coupling, friction based coupling, etc.).

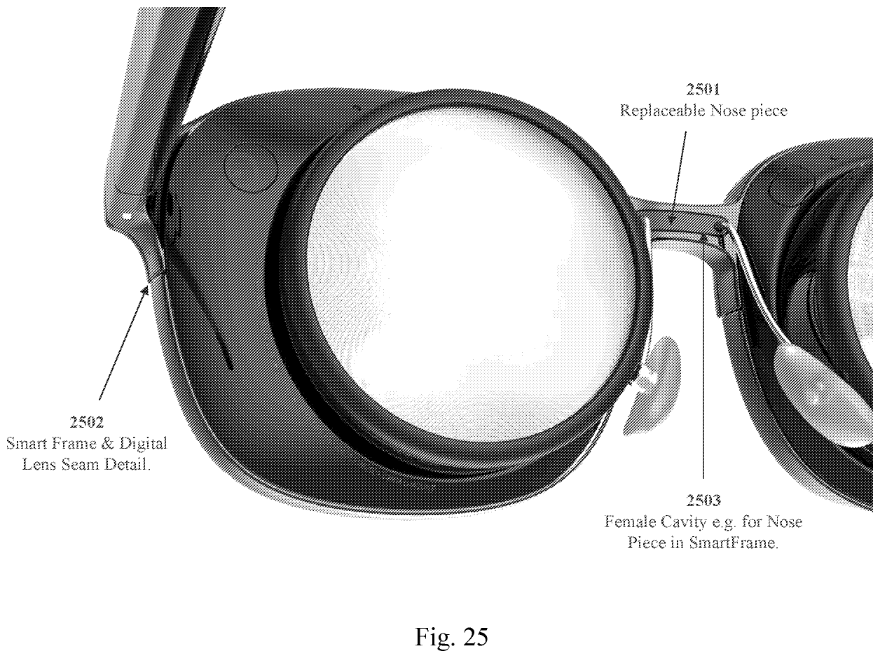

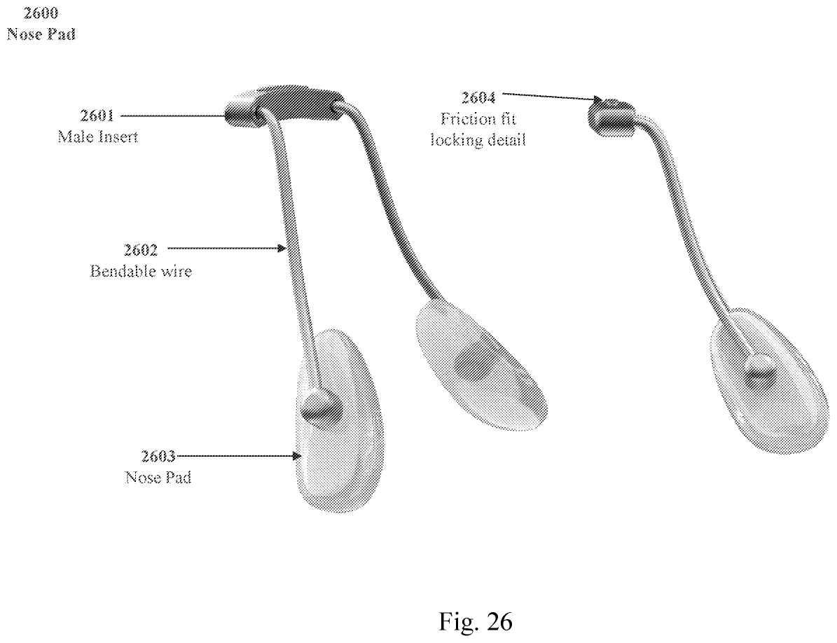

FIG. 26 shows a perspective view and a side view of an exemplary nose piece 2600 used with an augmented reality apparatus, according to some embodiments. The nose piece 2600 includes a male insert 2601 that can be configured to engage or couple with a female cavity or counter engagement feature on a smart frame. In some embodiments, the male insert 2601 of the nose piece 2600 can include a friction fit 2604 locking detail or feature configured to engage with the counter engagement feature on a smart frame. The nose piece 2600 includes a bendable wire 2602 and a nose pad 2603.

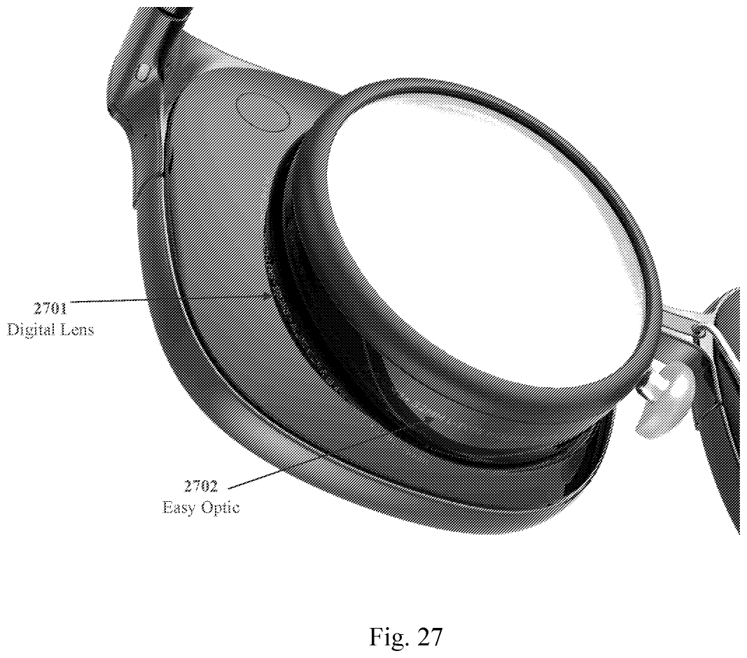

FIG. 27 provides a perspective bottom view of a digital lens 2701 including an easy optic 2702 used with a smart frame in an augmented reality apparatus, according to some embodiments.

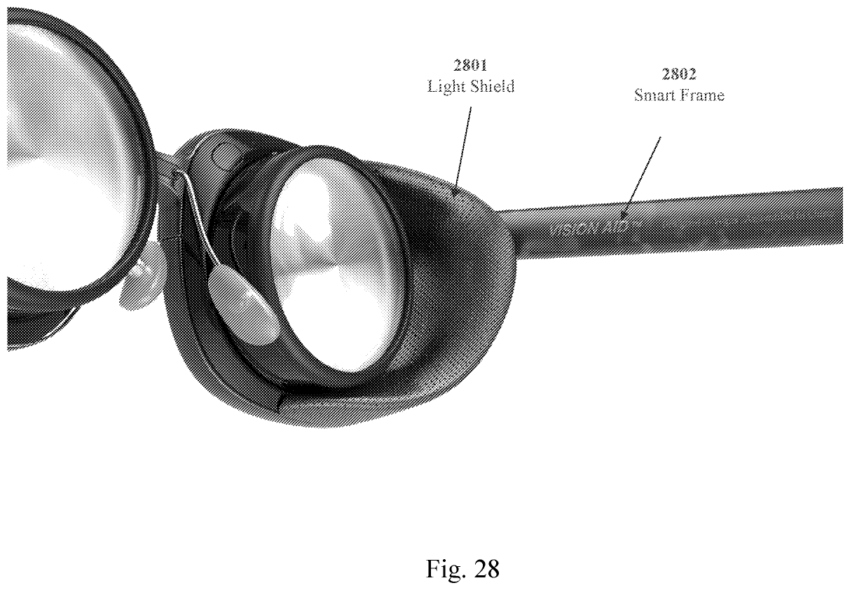

FIG. 28 provides a perspective side view of an augmented reality apparatus, according to some embodiments. The apparatus includes a smart frame 2802 coupled to a digital lens, and a light shield 2801 located on a lateral portion of the digital lens (e.g., lateral to an easy optic included in the digital lens). The light shield 2801 is configured to block entry of ambient light into the easy optic and/or digital lens during use of the apparatus.

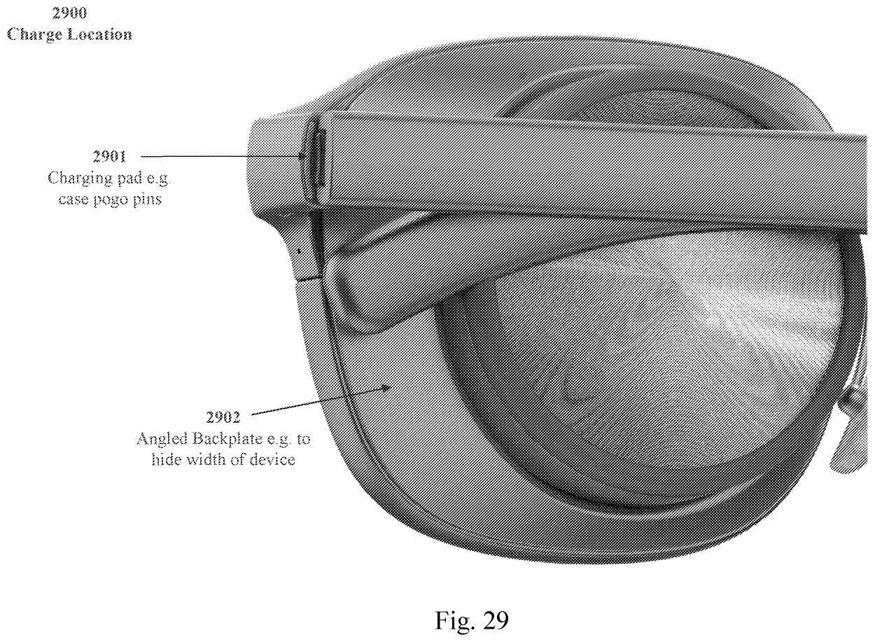

With reference to FIG. 29, in some embodiments, an augmented reality apparatus 2900 may include suitable adaptations to charge and/or provide data communication access to the apparatus as necessary. The apparatus 2900 includes a smart frame that includes a frame and arms located on either side of the frame. The arms may be coupled to the frame via hinge joints such that the arms may be bent or folded in when not in use. The apparatus 2900 includes a charging pad 2901 located within hinge joint coupling an arm with a frame of the apparatus 2900. The charging pad can also be used for data communications between the apparatus and an external device (e.g., for sending and receiving signals to and from the apparatus 2900). In some embodiments, the charging pad 2901 can have pogo pins providing electrical connections for transfer of power and/or data using a wired connection. In some embodiments, the charging pad 2901 can include any suitable device configured to support wireless transfer of power and/or data. The apparatus 2900 includes an angled backplate 2902 of the digital lens to at least partially reduce and/or hide a width of the apparatus 2900. In some embodiments, the charging pads are hidden from view when the temples/arms are fully extended. The rear of digital lens may be angled so as to hide the width and depth of the device. The materials may be reflective to mimic the light that catches the backside of a pair of sunglasses and feel more natural.

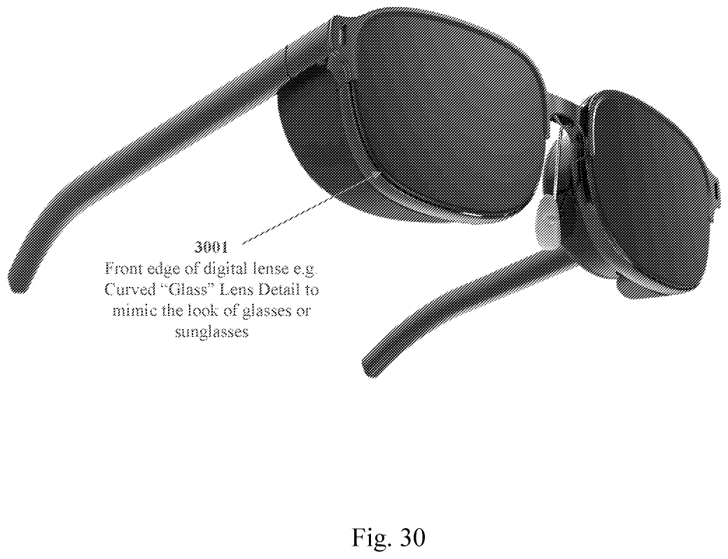

With reference to FIG. 30, in some embodiments, an augmented reality apparatus may include a front edge of a digital lens 3001 that can be curved. The front edge of the digital lens 3001 can be suitably configured to mimic an appearance of prescription glasses or sunglasses.

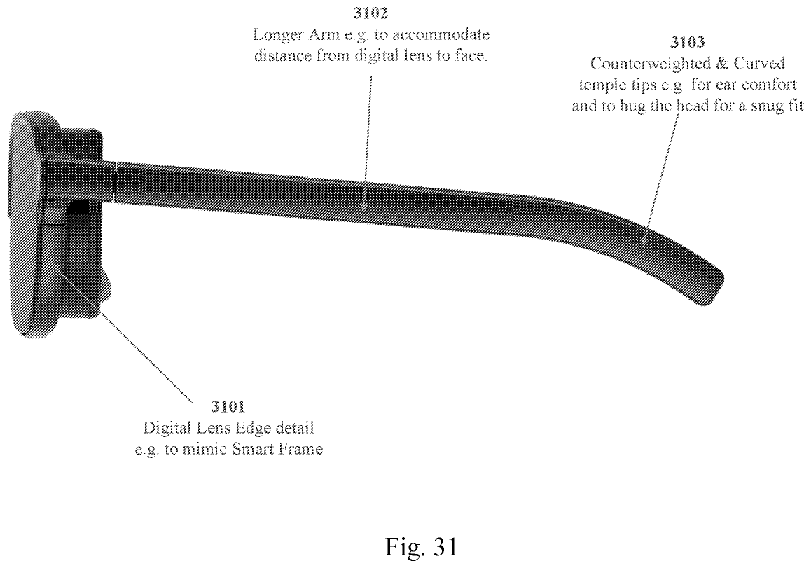

With reference to FIG. 31, in some embodiments, an augmented reality apparatus may include a digital lens with a digital lens including edge detail 3101 that may be configured to mimic the look and feel of its associated smart frame so that an observer of the augmented reality apparatus may not readily distinguish between the two. The apparatus can include arms configured to balance a weight of a front portion of the apparatus (e.g., portion including a frame, digital lenses, etc.). In some embodiments, the apparatus can include longer arms 3102 to accommodate a specified distance between the digital lens of the apparatus and a face of a user. In some embodiments, the arms or tips of the arms can be counterweighted (e.g., by providing counterweight at a rear end of the arms). In some embodiments, the arms or tips of the arms can be curved to provide a snug fit along a rear temple of a user. The curvature can be such that the tips of the arms conform to surfaces of a rear temple portion of a user's head with a snug fit against the head of the user while providing comfort over the ears of the user.

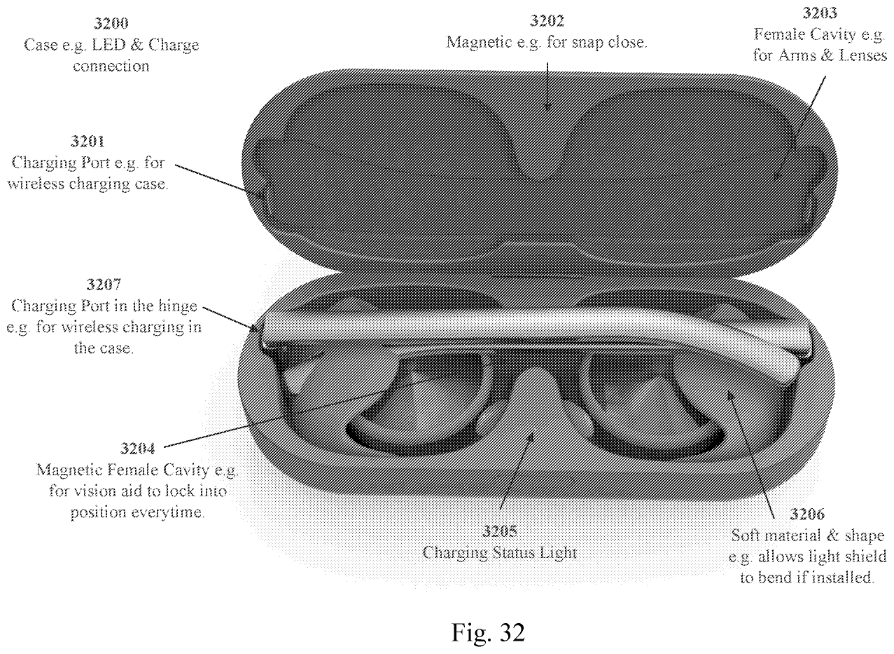

With reference to FIG. 32, in some embodiments, an augmented reality apparatus may be associated with a case 3200. Case 3200 may include a charging port 3201, e.g., for a wireless charging capability. For example, when an augmented reality apparatus (such as shown in FIG. 29) is folded for placing in case 3200, its charging pad (e.g., FIG. 29, element 2901 or FIG. 32, element 3207) may be exposed. When the augmented reality apparatus is placed in case 3200, the charging pad may physically and/or wirelessly connect with charging port 3201. Case 3200 may include a cover including sub-surface magnets for snapping close. The cover may also include a female cavity 3203 for accommodating the arms and digital lens system of the augmented reality apparatus. Case 3200 may further include a female cavity 3204 for accommodating the augmented reality apparatus. In some embodiments, the female cavity 3204 may include sub-surface magnets to assist in snapping and/or locking the augmented reality apparatus into place within the female cavity 3204. Case 3200 may further include a charging light 3205 indicating a status of charge of the augmented reality apparatus. For example, the bottom of the wireless charging case may have a status light that can change colors to communicate different information to the user, such as fully charged, charging, error (when flashing yellow), etc. In some embodiments, a light cover associated with the augmented reality apparatus may be made of a soft material and be configured with a shape such that it may be bent and/or folded to fit within the female cavities 3203 and/or 3204 of case 3200.

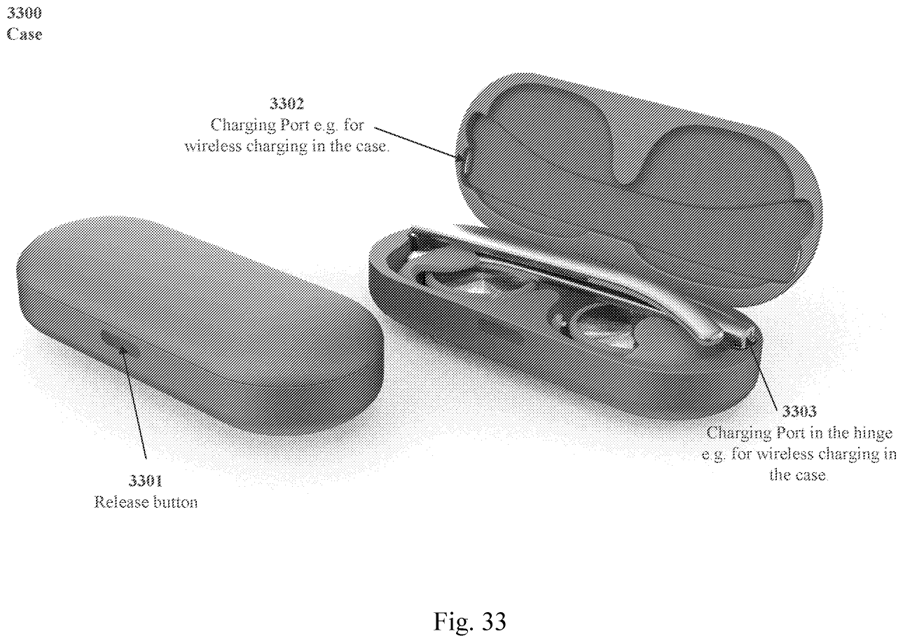

With reference to FIG. 33, in some embodiments, an augmented reality apparatus may be associated with a case 3300. The case 3300 may include a release button 3301 for opening the case 3300. The case 3300 may also include a charging port 3302 for wirelessly charging the augmented reality apparatus in the case 3300. For example, when an augmented reality apparatus (such as shown in FIG. 29) is folded for placing in case 3300, its charging pad or port (e.g., FIG. 29, element 2901, or FIG. 32, element 3207, or FIG. 33, element 3303) adjacent or within a hinge in the augmented reality apparatus may be exposed. When the augmented reality apparatus is placed in case 3200, the charging pad or port may physically and/or wirelessly connect with charging port 3202. In some embodiments, one or more charging pads or ports may be provided on one or more sides of the augmented reality apparatus, and one or more charging pads or ports may be provided on one or more sides of the case 3300.

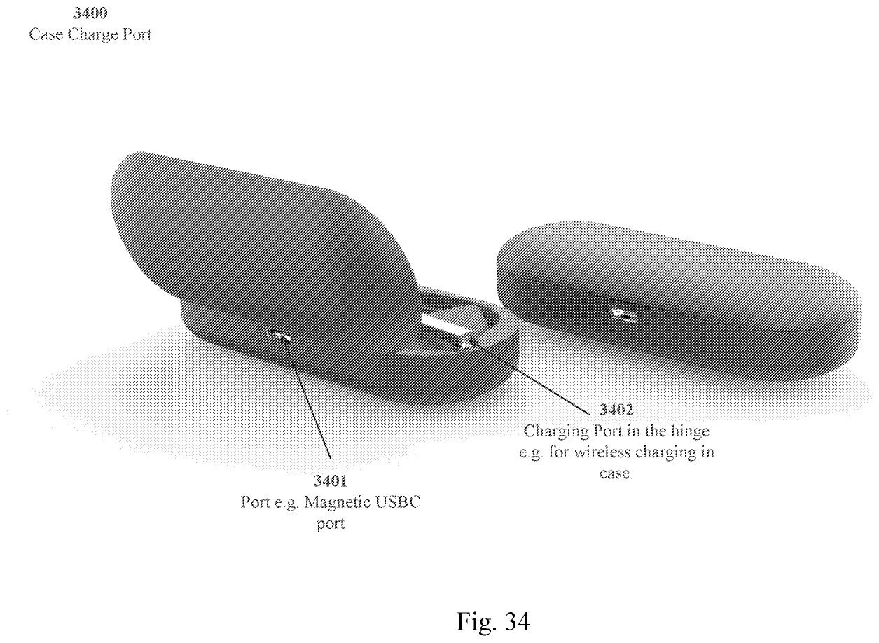

With reference to FIG. 34, in some embodiments, an augmented reality apparatus may be associated with a case 3400. The case 3400 may include a port 3401, e.g., for providing a data connection and/or powering the case 3400. For example, the charging port may be a magnetic USB-C port. Port 3401 may provide an electrical connection for communicating data and/or power to a charging port 3402 included in an augmented reality apparatus that is being accommodated in case 3400.

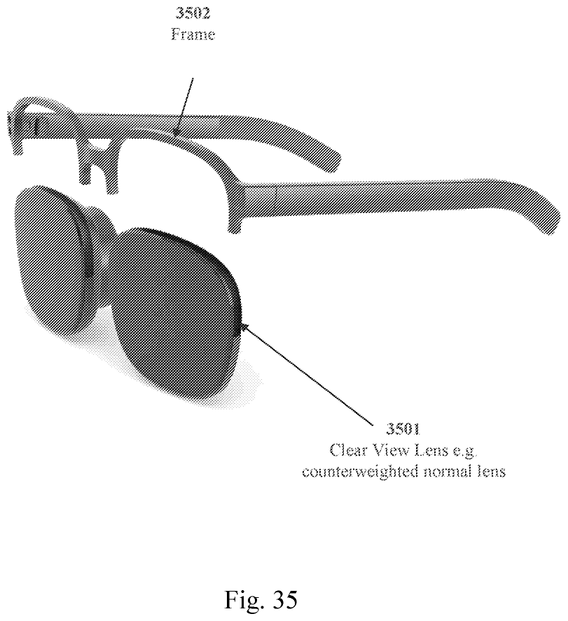

With reference to FIG. 35, in some embodiments, an augmented reality apparatus may include a partial frame 3502 and a lens 3501. The lens 3501 may include a counterweight in order to balance the weight from other components included in the augmented reality apparatus.

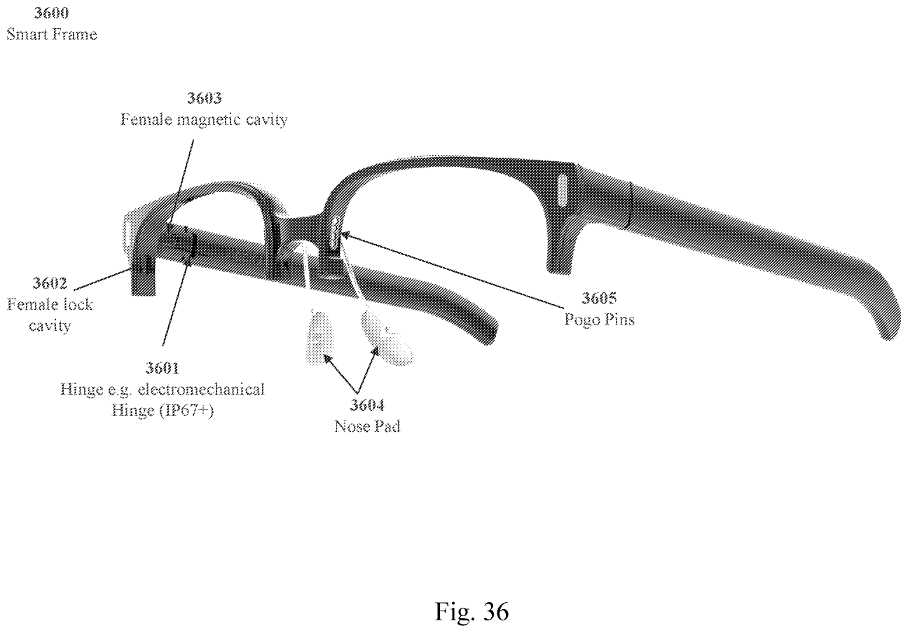

With reference to FIG. 36, in some embodiments, an augmented reality apparatus may include a smart frame 3600, which may include mechanical, electrical, battery, and/or sensor components as discussed above. Smart frame 3600 may further include an electromechanical hinge 3601, which may facilitate folding of the augmented reality apparatus for placement in a case. Electromechanical hinge 3601 may also facilitate electrical connection with the case for data communication or power charging, as discussed above. Smart frame 3600 may also include a female lock cavity 3602, for locking a lens, digital lens system, or a mechanical or optical component in place with the smart frame 3600. Smart frame 3600 may further include a female magnetic cavity 3603 for accommodating a lens, digital lens system, light shield, or optical component in place using sub-surface magnets embedded within smart frame 3600. Smart frame 3600 may further include a nose pad. Smart frame 3600 may further include pogo pins 3605. In some embodiments, pogo pins 3605 may facilitate mechanical positioning and alignment of a lens, digital lens system, or a mechanical or optical component with the smart frame 3600. In some embodiments, pogo pins 3605 may also facilitate an electrical connection, for communicating data or power charging, between the smart frame 3600, digital lens system, and any other electrical, opto-electronic, electro-optic, or electronic components in or associated with the augmented reality apparatus.

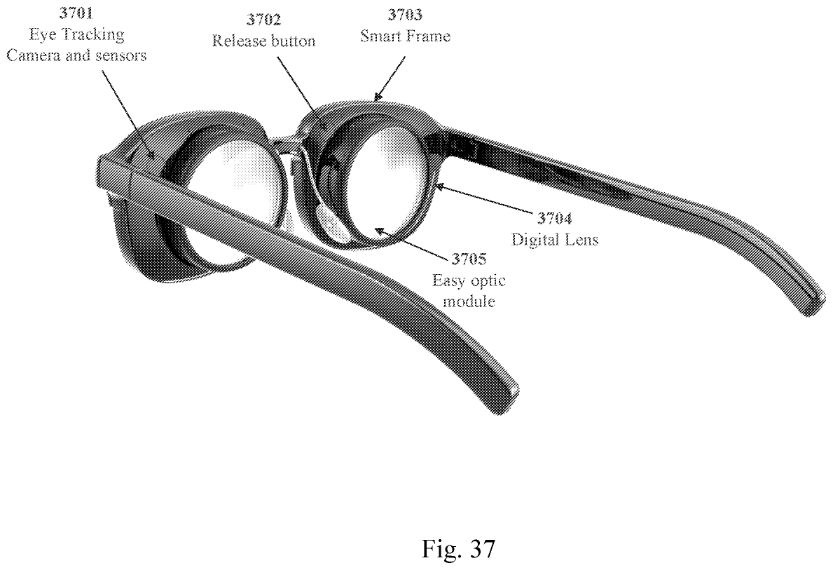

With reference to FIG. 37, in some embodiments, an augmented reality apparatus may include a smart frame 3703, which may include mechanical, electrical, battery, and/or sensor components as discussed above. Smart frame 3703 may interface with a digital lens 3704. Digital lens 3704 may include an easy optic module 3705. Digital lens 3704 may also include a release button 37023 for manually releasing the digital lens 3704 from smart frame 3703. Digital lens 3704 may also include an eye tracking camera and/or sensors 3701 for tracking eye movements of a person wearing the augmented reality apparatus.

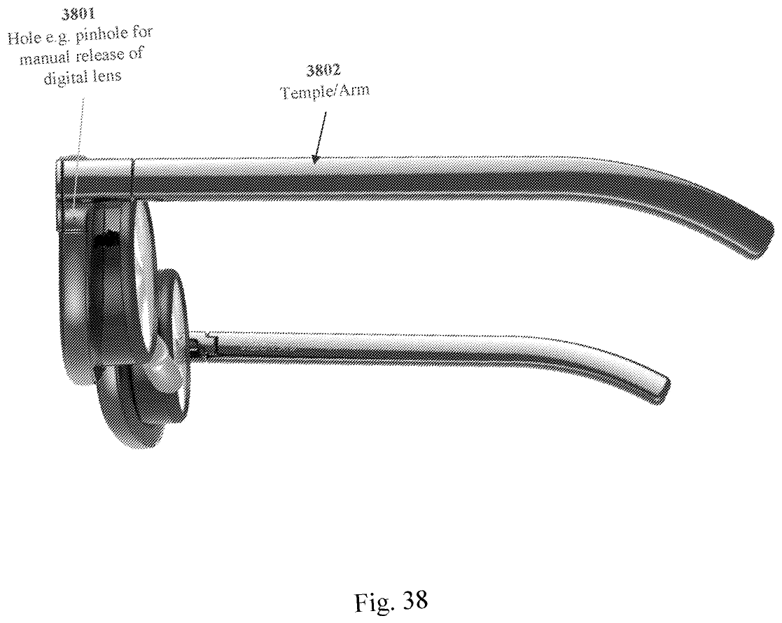

With reference to FIG. 38, in some embodiments, an augmented reality apparatus may include a pinhole 3801 for manually releasing a digital lens from a smart frame of the augmented reality apparatus. Further, the augmented reality apparatus may include a temple/arm 3802, which may be counterweighted to offset the weight of other components associated with the augmented reality apparatus.

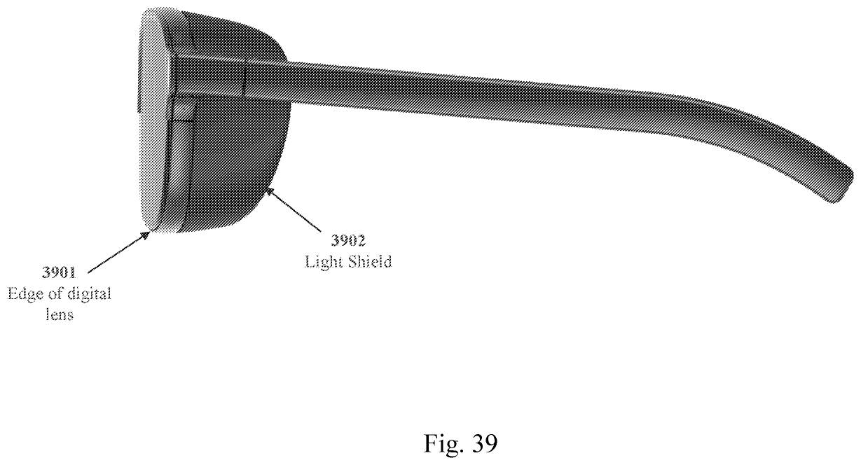

With reference to FIG. 39, in some embodiments, an augmented reality apparatus may include a light shield 3902. Light shield 3902 may interface with an edge 3901 of a digital lens associated with the augmented reality apparatus.

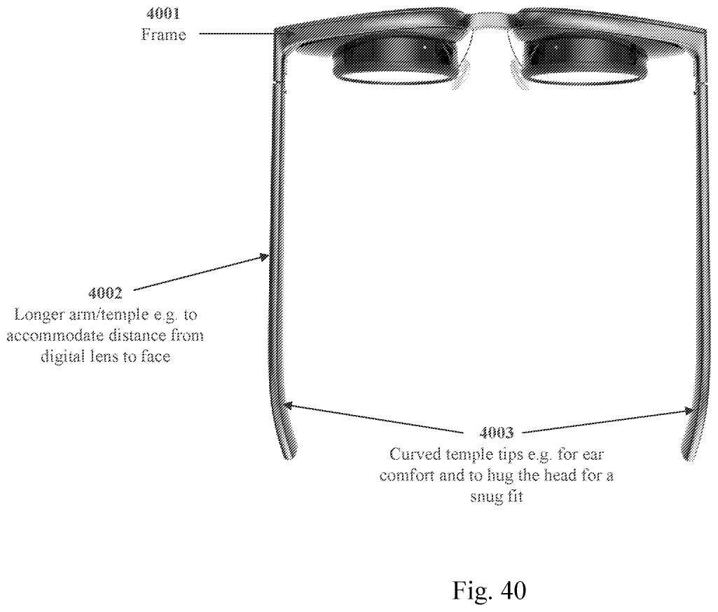

With reference to FIG. 40, in some embodiments, an augmented reality apparatus may include a frame 4001. In some embodiments, frame 4001 may include a longer arm/temple 4002, for example to accommodate a distance from the rear surface of the digital lens to the face of the person wearing the augmented reality apparatus. In some embodiments, frame 4001 may also include curved temple/arm tips 4003, for example for ear comfort and to hug the head for a snug fit.

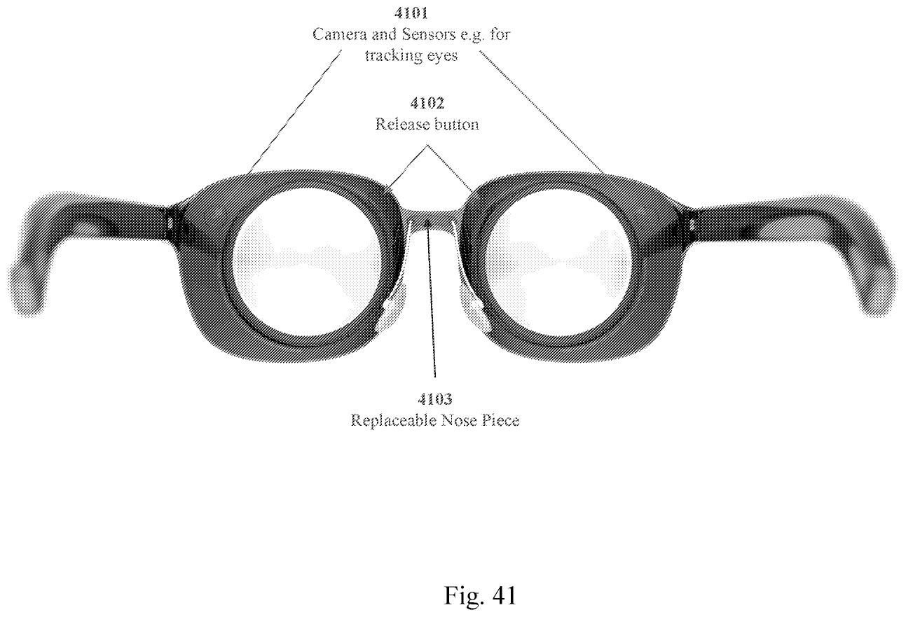

With reference to FIG. 41, in some embodiments, an augmented reality apparatus may include cameras and/or sensors 4101, for example to detect the presence of a person wearing the augmented reality apparatus and/or to track eye movements of such a person. In some embodiments, a digital lens system associated with the augmented reality apparatus may also include a release 4102 for manually releasing the digital lens system from a frame associated with the augmented reality apparatus. In some embodiments, the augmented reality apparatus may include a nose piece 4103 which may be removable and replaceable.

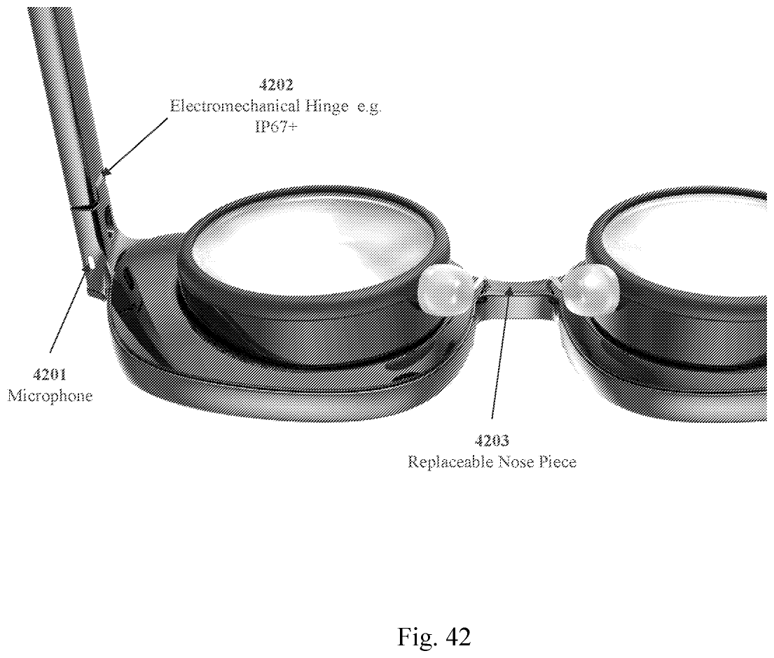

With reference to FIG. 42, in some embodiments, an augmented reality apparatus may include microphones 4201 on one or either side of the augmented reality apparatus. For example, the microphones 4201 may be located adjacent to or in proximity with an electromagnetic hinge 4202 associated with the augmented reality apparatus. Electromechanical hinge 4202 may be used at the joining of the front frame to the temples/arms. In some embodiments, electromagnetic hinge 4202 may be optimally rated to IP67 or better. In some embodiments, electromagnetic hinge 4202 may be of a bi-positional design so that it may naturally settle in one of two positions, fully closed or fully open.

Electromagnetic hinge 4202 may facilitate folding of the augmented reality apparatus for placement in a case, snapping and/or securing the augmented reality apparatus in place in the case, and also electrical connection with the case for data communication or power charging, as discussed above. In some embodiments, the augmented reality apparatus may include a nose piece 4203 which may be removable and replaceable.

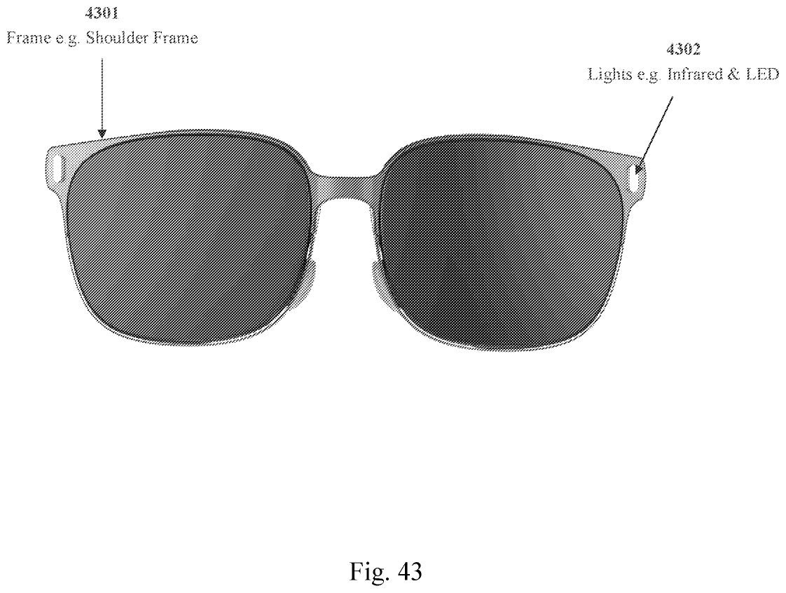

With reference to FIG. 43, in some embodiments, an augmented reality apparatus may include a frame 4301, which may be a shoulder frame. The frame 4301 may include lights 4302, e.g., infra-red and/or visible LED lights. The lights 4302, for example, may be included on either side of the frame 4301 adjacent an electromagnetic hinge (not shown) associated with the frame 4301.

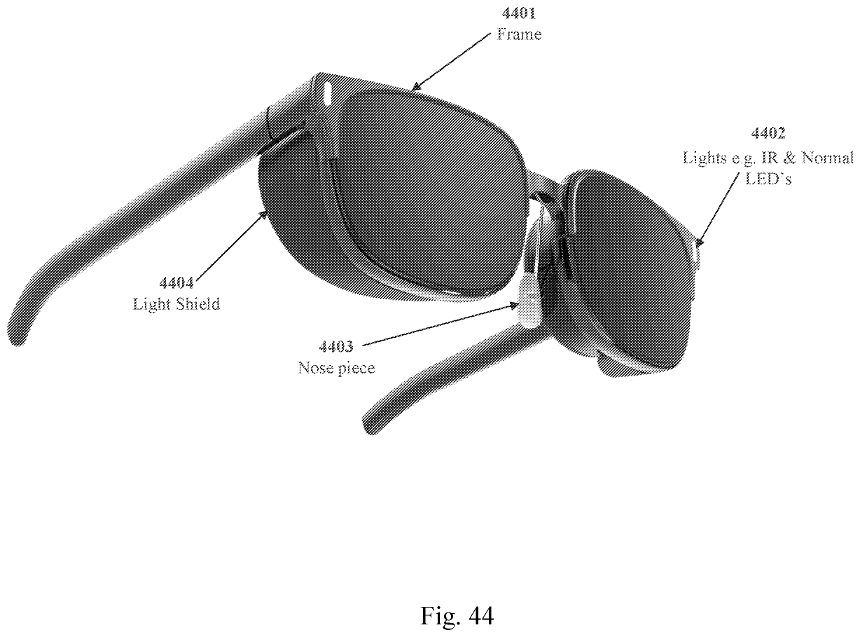

With reference to FIG. 44, in some embodiments, an augmented reality apparatus may include a frame 4401 with lights 4402 included on either side of the frame 4301 adjacent an electromagnetic hinge (not shown) associated with the frame 4401. Frame 4401 may also include a light shield 4404 located such that it may fully or partially shield the eyes of the person wearing the augmented reality apparatus from peripheral light sources, external light sources, or any sources of light other than a digital lens system associated with the augmented reality apparatus, and even from direct exposure to the lights 4402.

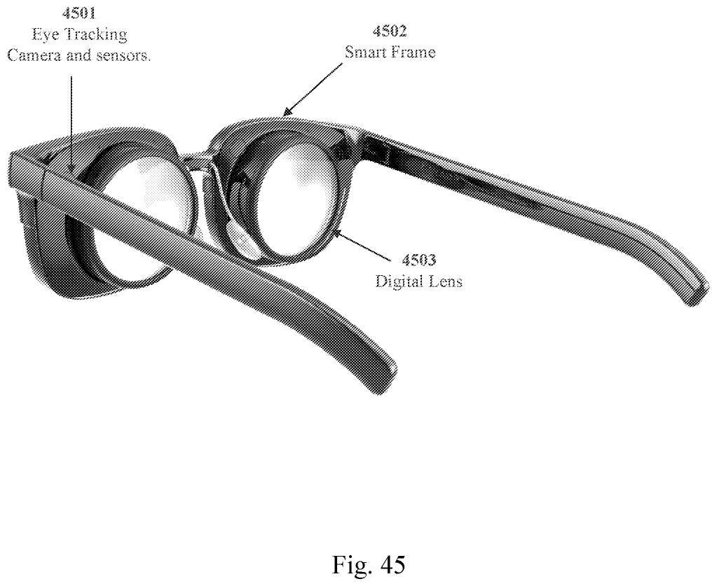

With reference to FIG. 45, in some embodiments, an augmented reality apparatus may include a smart frame 4502, which may include mechanical, electrical, battery, and/or sensor components as discussed above. Smart frame 4502 may interface with a digital lens 4503. Digital lens 4503 may also include an eye tracking camera and/or sensors 4501 for tracking eye movements of a person wearing the augmented reality apparatus.

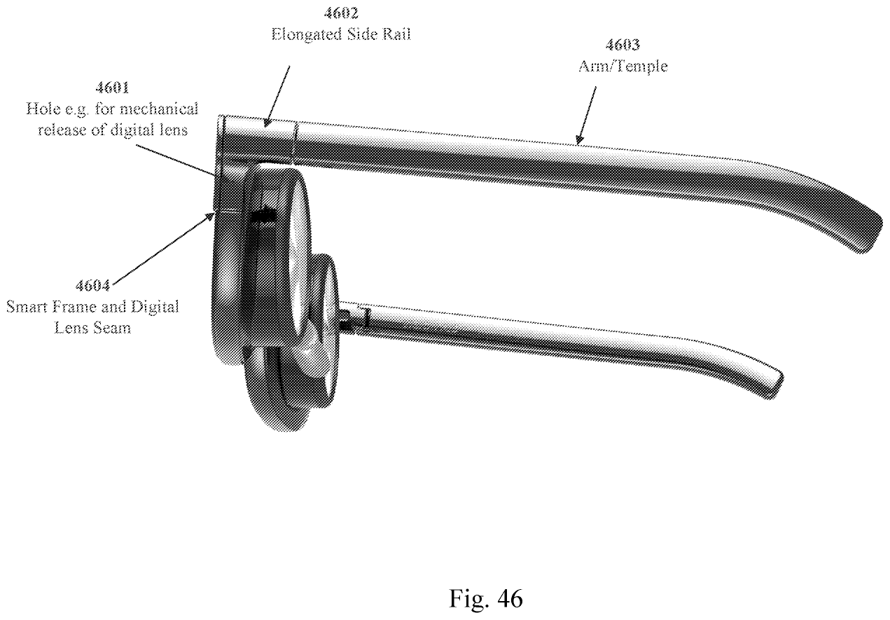

With reference to FIG. 46, in some embodiments, an augmented reality apparatus may include a pinhole 4601 for manually releasing a digital lens from a smart frame 4604 of the augmented reality apparatus. Further, the augmented reality apparatus may include an elongated side rail 4602, which may include microphones, accelerometers, gyroscopes, proximity sensors, motion sensors, PCBs, etc., as discussed above. Further, the augmented reality apparatus may include a temple/arm 4603, which may be counterweighted to offset the weight of other components associated with the augmented reality apparatus.

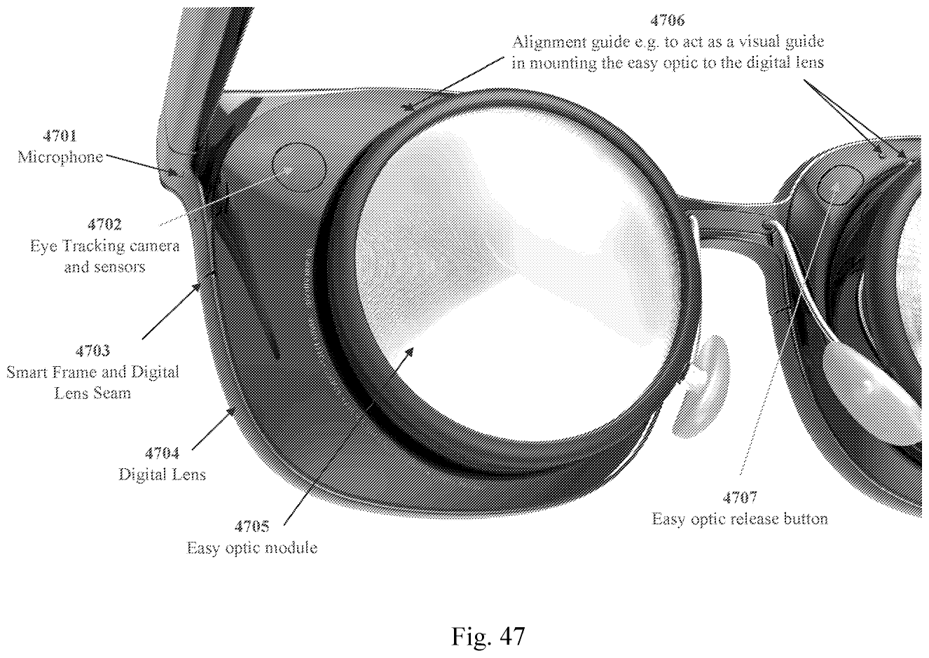

With reference to FIG. 47, in some embodiments, an augmented reality apparatus may include a smart frame 4703, which may include mechanical, electrical, battery, and/or sensor components as discussed above. For example, smart frame 4703 may include microphone 4701. Smart frame 4703 may interface with a digital lens 4704 via a digital lens seam (see 4703). Digital lens 4704 may include eye tracking cameras and/or sensors 4702, and interface with an easy optic 4705 to provide (prescription) optics for the person wearing the augmented reality apparatus. Digital lens 4704 may also include an alignment guide 4706, which may for example act as a visual guide in mounting the easy optic 4705 to the digital lens 4704. Digital lens 4704 may also include an easy optic release button 4707, to manually release the easy optic 4705 so that it may be easily replaced with another easy optic as needed. This button may allow the user to press and twist the easy optic to remove it from the digital lens.

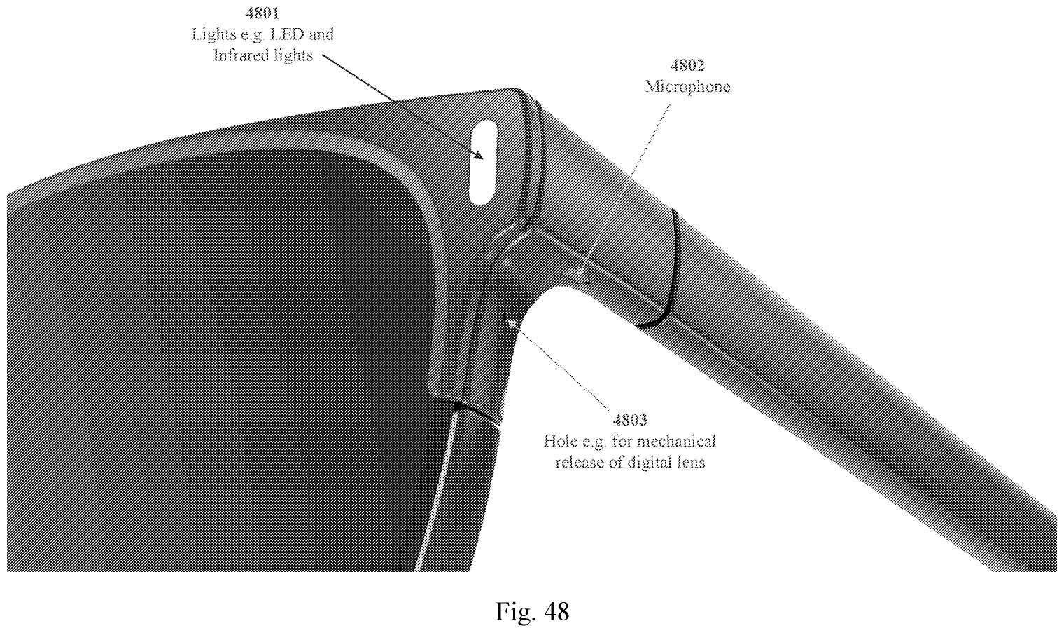

With reference to FIG. 48, in some embodiments, an augmented reality apparatus may include a frame with lights 4801 included on either side of the frame adjacent an electromagnetic hinge (not labeled) associated with the frame. The frame may include microphone 4802. The frame may also include a pinhole 4803 for manually releasing a digital lens system associated with the augmented reality apparatus from the frame.

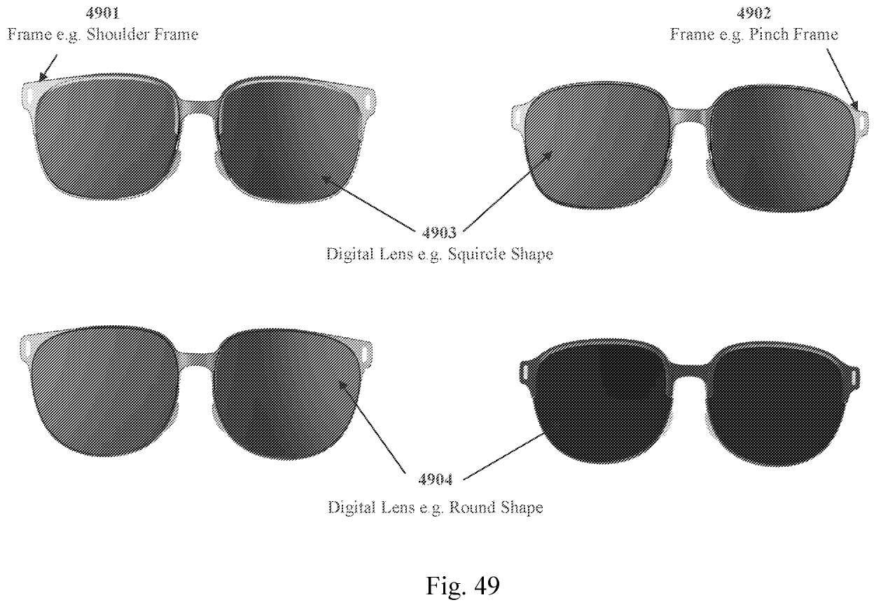

With reference to FIG. 49, in some embodiments, augmented reality apparatuses may include frames and digital lenses of various shapes and sizes. For example, the frames may be of shoulder (4901) or pinch (4902) shapes, and the digital lenses may be of squircle (4903) or round (4904) shapes.

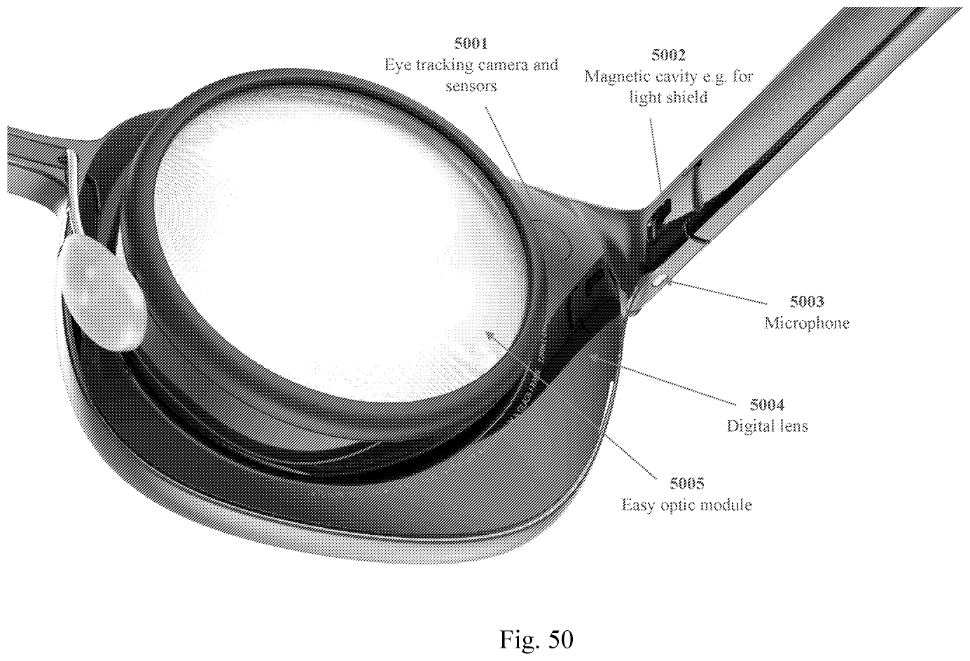

With reference to FIG. 50, in some embodiments, an augmented reality apparatus may include a frame that include microphone 5003. The frame may also include a magnetic cavity 5002 for a light shield to connect with the frame. For example, the light shield may fully or partially shield the eyes of the person wearing augmented reality 400 from peripheral light sources, external light sources, or any sources of light other than digital lens 5004. The magnetic cavity 5002 may facilitate positioning, alignment, snapping, and securing of the light shield with the frame. In some embodiments, the augmented reality apparatus may also include a digital lens 5004, which may include eye tracking cameras and/or sensors 5001 to detect the presence of and/or track eye movements of a person wearing the augmented reality apparatus. Digital lens 5004 may interface with an easy optic module 5005, which may, for example, provide prescription lenses for the person wearing the augmented reality apparatus.

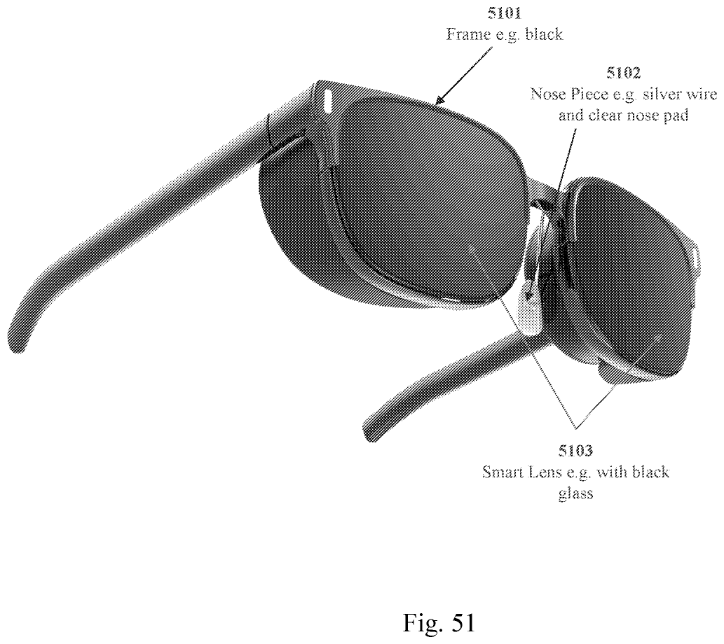

With reference to FIG. 51, in some embodiments, an augmented reality apparatus may include a frame 5101 with a nose piece 5102 and smart lens 5103 with black glass, such that the frame 5101, nose piece 5102, and smart lens 5103 obscure the other components of the augmented reality apparatus from external observers of the augmented reality apparatus.

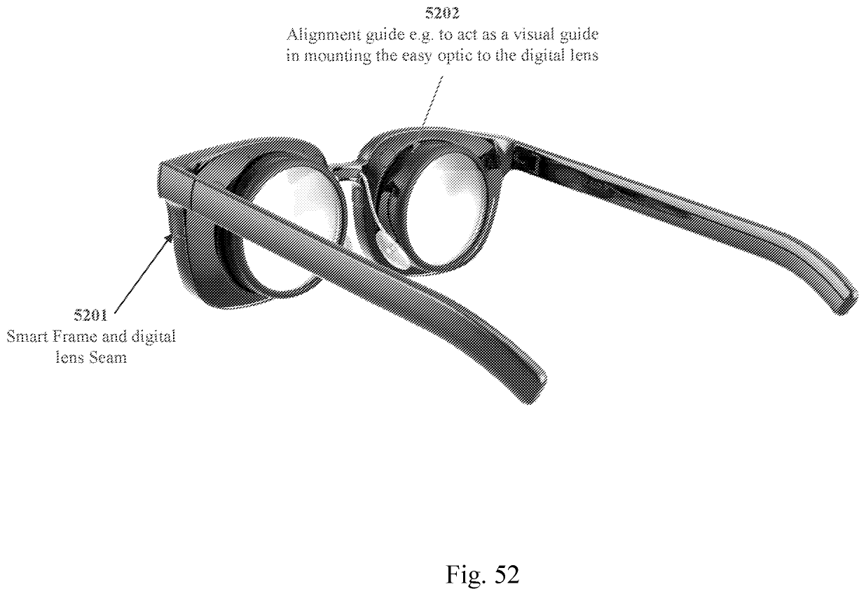

With reference to FIG. 52, in some embodiments, an augmented reality apparatus may include a smart frame 5201 including a seam with a digital lens system. The digital lens system may also interface with an easy optic. In some embodiments, the digital lens system may include an alignment guide 5202 to act as a visual guide in mounting the easy optic to the digital lens system.

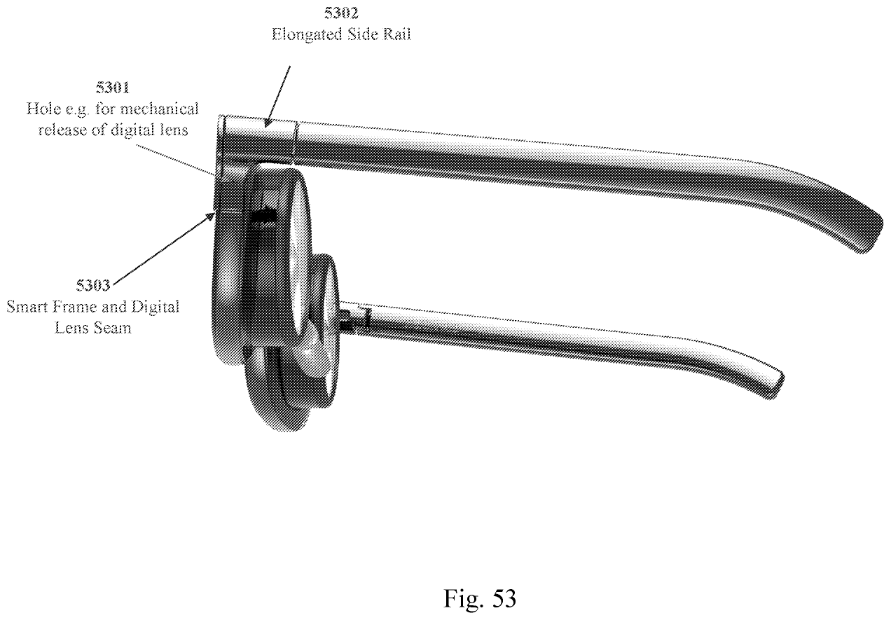

With reference to FIG. 53, in some embodiments, an augmented reality apparatus may include a smart frame including a seam 5303 with a digital lens system. Further, the augmented reality apparatus may include a pinhole 5301 for manually releasing a digital lens from a smart frame 5303 of the augmented reality apparatus. The augmented reality apparatus may include an elongated side rail 5302 that can be configured to include electrical/electronic components, and/or communication devices as necessary.

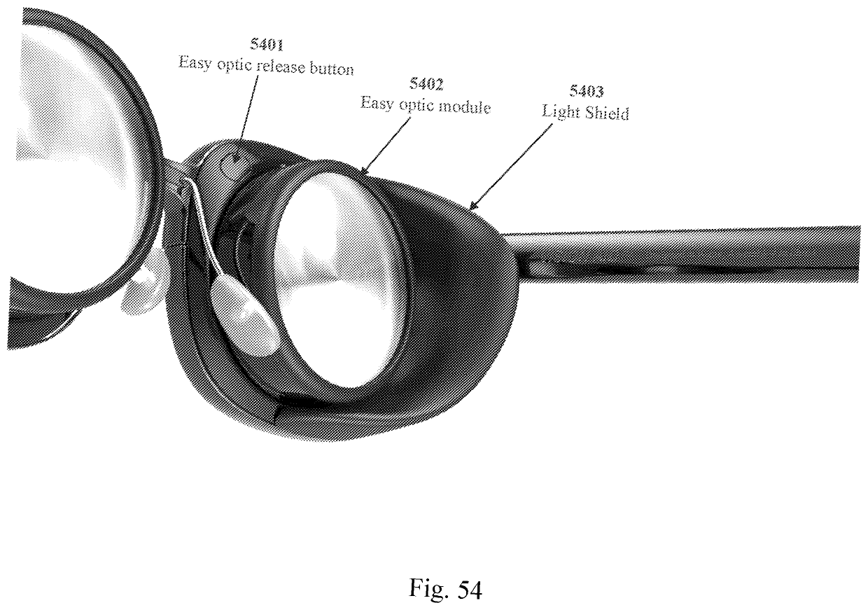

With reference to FIG. 54, in some embodiments, an augmented reality apparatus may include a light shield 5403 as discussed above, which interfaces with an easy optic module 5402. The easy optic module 5402 may interface with a digital lens system, and an easy optic release button 5401 may be provided on the digital lens system to manually release the easy optic module 5402 from the digital lens system.

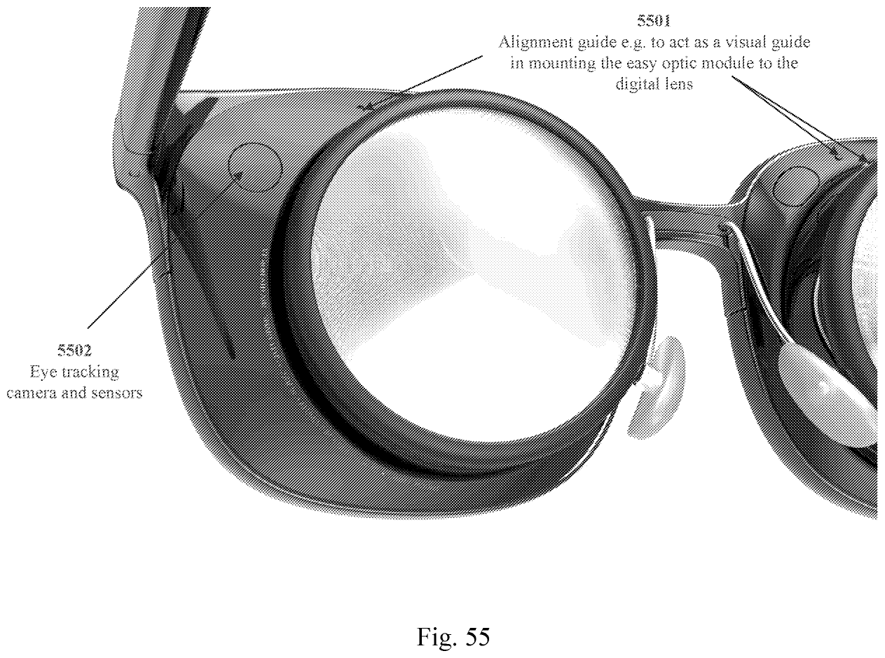

With reference to FIG. 55, in some embodiments, an augmented reality apparatus may include a smart frame interfacing with a digital lens. The digital lens may include eye tracking cameras and/or sensors 5502, and interface with an easy optic to provide (prescription) optics for the person wearing the augmented reality apparatus. The digital lens may also include an alignment guide 5501, which may for example act as a visual guide in mounting the easy optic to the digital lens.

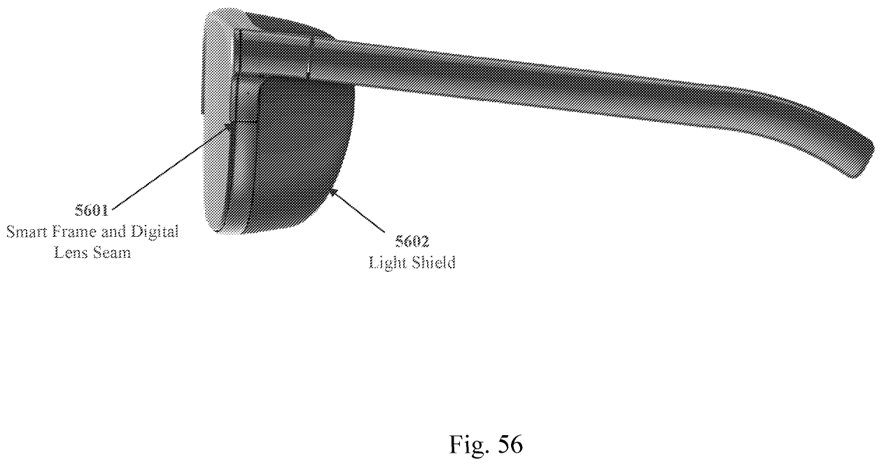

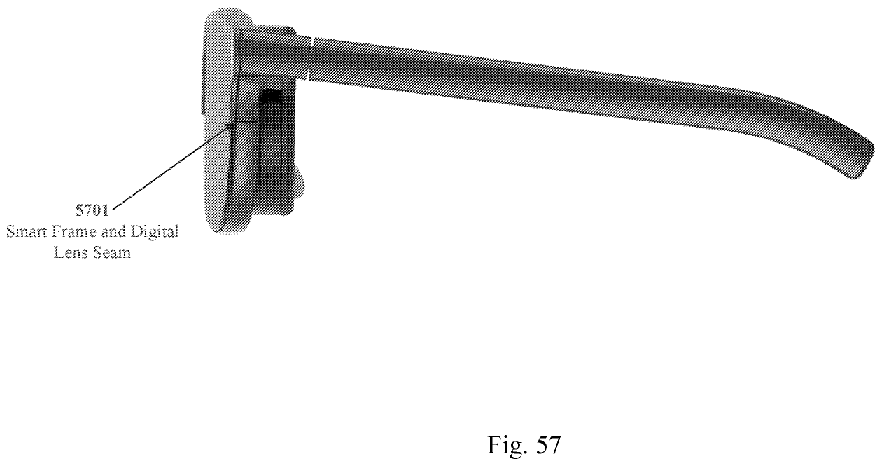

With reference to FIG. 56, in some embodiments, an augmented reality apparatus may include a smart frame 5601, which may include mechanical, electrical, battery, and/or sensor components as discussed above. Smart frame 5601 may interface with a digital lens via a digital lens seam (see 5601). The smart frame 5601 may also interface with a light shield 5602 located such that it may fully or partially shield the eyes of the person wearing the augmented reality apparatus from peripheral light sources, external light sources, or any sources of light other than a digital lens system associated with the augmented reality apparatus. With reference to FIG. 57, in some embodiments, the light shield 5602 may obscure the digital lens system and easy optic from a side of the augmented reality apparatus, but not obscure the smart frame 5701 or its seam with the digital lens system. Additional exemplary embodiments are described below.

### Lanyard

A lanyard may easily attach to both arms of a smart frame at the temple tips, and allow the user to easily hang their augmented reality apparatus around their neck when in intermittent use, and serves as protection from dropping, while keeping them easy to access. Some models of the lanyard may have different internals that increase functionality and utility like interior batteries at the base of the neck for counterweight and extended battery life.

### Cane IQ

A smart cane may be made to be handled in the hand and used similar to a cane for the blind. It may perform the processing for and supplement processing to the various smart frame models and offer internet-connected service that wirelessly transmits and communicates with the augmented reality apparatus for advanced software features. This may help keep the size of the smart frames down while offering optional advanced computing technologies. The smart cane may be outfitted with Lidar, Cameras, UltraSonic, Gyros, pressure sensors and infrared sensors in all directions to create a 360 degree computer vision system optimal for pedestrian navigation by foot. This data can then be used to provide real-time navigation assistance similar to self-driving cars and GPS to provide hazard & obstruction detection, fall detection, changes in ground surface variation and hardness, for an array of early warning systems & guidance. Haptics may be activated around the handhold in the direction of the objects around the device. Intensity of the haptics can also be adjusted based on the distance between the person and the object. Sound can also be employed through speaker systems to announce and communicate with the user in a friendly manner or sent to compatible devices.

### Belt IQ

A smart belt may be made to be worn and look like a stylish and normal belt. It can do the processing for and supplement processing to the various smart frame models and offer internet connected service that wirelessly transmits and communicates with the augmented reality apparatus for advanced software features. This may help keep the size of the smart frames down while offering optional advanced computing technologies. The smart belt may be outfitted with Lidar, Cameras, Ultra Sonic, and infrared sensors in all directions to create a computer vision system optimal for pedestrians navigation by foot. This data can then be used to provide real-time navigation assistance similar to self-driving cars and GPS to provide hazard & obstruction detection, fall detection, and early warning & guidance. Haptics may be activated around the individual in the direction of the objects around the device. Intensity of the haptics can also be adjusted based on the distance between the person and the object. Sound can also be employed through speaker systems to announce and communicate with the user in a friendly manner or sent to compatible devices.

### BoxIQ

BOXIQ may be made to be worn at the hip or belt if cane is not needed and additional computer vision and hazard detection is not needed but advanced software features are desired. It can do the processing for and supplement processing to the various smart frame models and offers internet connected service that wirelessly transmits and communicates with the augmented reality apparatus for advanced software features. This may help keep the size of the smart frames down while offering optional advanced computing technologies.

Alternative Use Cases of the augmented reality apparatuses are provided below. The disclosed augmented reality apparatuses have many emerging use cases that may require “remote assistance.”, “remote viewing”, and/or “remote communication, or Augmented Reality solutions where full occlusion may be useful to the experience.
Enterprise, B2B, & B2C.
Security and First Responders.
Prosumers.
Opportunities in the Defense, aviation, industrial, medical, consumer, education, visual search, courier services and automotive sectors.

### Tele-Emergency Services and Tele-Convenience Services

Remote Emergency Assistance
   Subscription-based communications, security & emergency services, hands-free calling, turn-by-turn navigation, and remote diagnostics systems, Remote visual support throughout the United States, & world.
General Remote assistance
   Ability for professionals to provide assistance to VISIONAD users by access the visual display that the users are also seeing in a real-time stream. These professionals can provide assistance such as: reading labels, providing navigation, and identifying contextual environment information which the user is unable to see/process.

### Tele-Medicine

Remote Video and Recording
   Professional point of view
      Doctors
      Nurses
      Paramedics
   Patient point of view
      Eye Patients
      In HMD eye tests using eye cam & Front facing cameras, & displays.
Procedure Assistance

### Warehouse Logistics

Barcode Scanning
Order Picking & Fulfillment
Video Recording
Inventory

### Field Service

### Remote Support

Maintenance & trouble-shooting
   Resolve maintenance issues without need to have an expert on site.
Audits:
   Complete audit without need for travel
Field Service
   Walkarounds
      Remote view a walk around without the need to travel. Or have one walkaround with multiple viewers simultaneously.
Training

### Manufacturing

Work Instructions
Video/Step Confirmation & Quality Assurance

### Tele-Presence

Stream augmented reality communication which is best suited with occluded visuals
   People & objects

### Entertainment

Stream augmented reality content that is best suited with occluded visuals.
   Movies, shows & more.

### Productivity

Stream augmented reality content that is best suited with occluded visuals.
Productivity apps

### Enhanced Vision for Normal Sighted Individuals.

Binocular zoom
Better low light vision
Ai assisted visual aid.

### Vision Assistance for Dogs.

The augmented reality apparatuses can be outfitted with special straps to work for dogs.

The specification has described augmented reality systems and methods for the visually impaired. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. An augmented-reality electronic glass apparatus, comprising:
a smart frame, comprising:
a printed circuit board,
a light emitting diode,
a battery, and
a communication module with integrated antenna; and
a digital lens, comprising:
a liquid crystal device display,
a lens assembly,
a magnetic stackable optic,
an eye tracking system,
a camera module,
a lidar module,
wherein the digital lens is magnetically attached to the smart frame.
